(19) United States
(12) Patent Application Publication
(10) Pub. No.: US 2006/0262347 A1
(43) Pub. Date: Nov. 23, 2006

(54) Information processing apparatus and device selection method

(75) Inventor: Takashi Ono, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/410,107

(22) Filed: Apr. 25, 2006

(30) Foreign Application Priority Data
May 17, 2005 (JP) 2005-144226

(51) Int. Cl. G06F 3/12

(52) U.S. Cl. 358/1.15; 358/1.13

(57) ABSTRACT

An information processing apparatus is connected to an image forming apparatus and a finisher as available devices via a network. The information processing apparatus acquires the device information of the available device, causes a user to select the available device based on the acquired device information to set a printing function for the selected available device. The information processing apparatus also generates printing control information for causing the selected device to execute the set printing function, and transmits the generated printing control information to the selected device.

### FIELD OF THE INVENTION

The present invention relates to an information processing apparatus connected to an image forming apparatus and finisher as available devices via a network, and a setting method therefor.

### BACKGROUND OF THE INVENTION

Conventionally, as methods of using the feature information of a finisher in generating a printing job in a host computer, there have been proposed a method of controlling printing attributes in printing, and a method of controlling the function items of the user interface of a printer driver.

Also, as the method of controlling printing attributes in printing by using the feature information of a finisher, the printer driver automatically sets printing attributes in generating a printing job in accordance with the feature information of the finisher. For example, in prior art 1 (Japanese Patent Laid-Open No. 2004-078449), a printing data storage unit acquires information on the following two items associated with a bookbinding apparatus included in the printing apparatus:

(1) information representing whether to pick up a paper sheet from the “top” of a set document stack or from the “bottom” ; and

(2) information representing whether to set a document with facing up or down.

Based on these pieces of information, the page output order (ascending/descending order) and the page output face (face-up/face-down) are so automatically set as to allow an operator to directly set a printout product on the bookbinding apparatus and normally bind the product.

In prior art 2 (Japanese Patent Laid-Open No. 2002-036669), in printing and bookbinding, a printer driver dynamically determines the face order of printing data based on a saddle stitching direction of a printer to generate the printing data. Since this control is performed by the printer driver, the user need not recognize information pertaining to a print face for the bookbinding apparatus.

Also, as a method of controlling the function item of the user interface of a printer driver based on the feature information of a finisher, there has been proposed a method of manually or automatically identifying the type of finisher mounted in a printer, and controlling the function item of the user interface. In this method, when a finisher capable of stapling is connected, the staple setting item of the user interface of the printer driver is validated so that the user can set stapling.

In recent years, when a page is to be edited on an application side, the page can be edited on the application side on the basis of jobs processable by an image forming apparatus such as a printer or MFP, and a finisher (inline finisher) connected to the image forming apparatus. The image forming apparatus and the inline finisher can also be controlled by setting the UI of a printer driver or the like.

However, in the above-described prior art, only an inline finisher serving as a bookbinding apparatus in a printing apparatus is considered, and a delivery face (print face) is automatically determined by using a program such as a printer driver dedicated to the printing apparatus. Hence, when a near-line finisher connected via a network is introduced to such print system in addition to the inline finisher, since the application acquires information only via the printer driver and an API, a page editing operation cannot be performed on the application side on the basis of a job processable by the near-line finisher, unlike the inline finisher.

Also, even when a user recognizes a job processable by a near-line finisher, and the page editing operation is performed on the basis of the recognized job, it is difficult to recognize the job processable by combining a plurality of finishers, and the page editing operation cannot easily be executed.

### SUMMARY OF THE INVENTION

The object of the preset invention is to provide a user with a user interface for selecting an image forming apparatus and a finisher independent of the image forming apparatus as available devices, and setting a printing function for the selected device.

In order to achieve the above object, according to an aspect of the present invention, there is provided an information processing apparatus which can communicate, via a network, with an image forming apparatus and a finisher independent of the image forming apparatus as available devices, comprising: acquisition means for acquiring pieces of device information of the image forming apparatus and the finisher as the available devices; selection means for causing a user to select the image forming apparatus and the finisher as the available devices based on the device information acquired by the acquisition means; setting means for causing the user to set a printing function and a post-processing function for the available device selected by the selection means; generation means for generating printing control information for causing the selected image forming apparatus to execute the printing function set by the setting means, and generating job control information for causing the selected finisher to execute the post-processing function set by the setting means; and transmission means for transmitting, to the respective selected devices, the printing control information and the job control information which are generated by the generation means.

According to another aspect of the present invention, there is provided a device selection method for an information processing apparatus which can communicate, via a network, with an image forming apparatus and a finisher independent of the image forming apparatus as available devices, comprising: an acquisition step of-acquiring pieces of device information of the image forming apparatus and the finisher as the available devices; a selection step of causing a user to select the image forming apparatus and the finisher as the available devices based on the device information acquired in the acquisition step; a setting step of causing the user to set a printing function and a post-processing function for the available device selected in the selection step; a generation step of generating printing control information for causing the selected image forming apparatus to execute the printing function set in the setting step, and generating job control information for causing the selected finisher to execute the post-processing function set in the setting step; and a transmission step of transmitting, to the respective selected devices, the printing control information and the job control information which are generated in the generation step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a view showing an example of a system configuration according to the first embodiment;

FIG. 2 is a block diagram showing an example of the structure of a server shown in FIG. 1;

FIG. 3 is a flowchart showing device addition processing in a server 201;

FIG. 4 is a table showing an example of the structure of a device management table;

FIG. 5 is a flowchart showing processing of acquiring or confirming device information in the server 201;

FIG. 6 is a block diagram showing an example of the structure of a client PC shown in FIG. 1;

FIG. 7 is a block diagram showing a software architecture in a client PC 601;

FIGS. 8A and 8B are views showing examples of the structures of a book file,

FIGS. 9A and 9B are tables showing a list of book attributes;

FIG. 10 is a table showing a list of chapter attributes;

FIG. 11 is a table showing a list of page attributes;

FIG. 12 is a flowchart showing procedures when a bookbinding application 704 opens a book file;

FIG. 13 is a view showing an example of a user interface (UI) window;

FIG. 14 is a block diagram showing an example of the structure of an image forming apparatus shown in FIG. 1;

FIG. 15 is a block diagram showing an example of the internal structure of a near-line finisher shown in FIG. 1;

FIG. 16 is a flowchart showing finisher profile transfer processing of the near-line finisher shown in FIG. 15;

FIG. 17 is a view showing an example of describing the finisher profile of a bookbinding apparatus;

FIG. 18 is a view showing an example of describing the finisher profile of a cutting apparatus;

FIGS. 19A and 19B are views showing examples of pieces of function information acquired from a printer driver 706 by a bookbinding application 704;

FIG. 20 is a view showing a device selection window in the bookbinding application 704;

FIG. 21 is a view showing an example of a setting window when a near-line finisher is selected;

FIG. 22 is a flowchart showing sequential processing in the client PC 601;

FIG. 23 is a table showing an example of a device management table for managing device information in the client PC 601;

FIG. 24 is a view showing, as one of edit information tables, an example of an output form table for managing a device for each output form in the client PC 601;

FIG. 25 is a flowchart showing detailed procedures in device management table generation processing (S2201) shown in FIG. 22;

FIG. 26 is a view showing, as one of edit information tables, an example of an imposition edit table for managing an imposition method available by combining devices in the client PC 601;

FIG. 27 is a flowchart showing detailed procedures in edit information table generation processing (S2203) shown in FIG. 22;

FIG. 28 is a flowchart showing detailed procedures in imposition setting processing (S2204) shown in FIG. 22;

FIGS. 29A and 29B are views showing examples of UI windows for performing device setting and imposition setting in a state wherein only the image forming apparatus is connected on a network;

FIGS. 30A and 30B are views showing examples of UI windows for performing device setting and imposition setting in a state wherein the image forming apparatus and the finisher are connected on the network;

FIG. 31 is a view showing an example of preview display after the end of device setting and imposition setting shown in FIGS. 30A and 30B;

FIG. 32 is a flowchart showing detailed procedures in printing processing (S2205) shown in FIG. 22;

FIG. 33 is a flowchart showing printing processing in the image forming apparatus;

FIG. 34 is a flowchart showing job control in the near-line finisher;

FIG. 35 is a flowchart showing printing processing in a client PC according to the second embodiment; and

FIG. 36 is a view showing an example of a UI window for selecting the combination of devices.

### DETAILED DESCRIPTION OF THE PREFERRED EMBODIMENTS

Preferred embodiments of the present invention will now be described in detail in accordance with the accompanying drawings.

### First Embodiment

<System Configuration>

In the first embodiment, an information processing apparatus will be described by exemplifying a client computer (to be referred to as a client PC hereinafter) in a server-client system in a case wherein an image forming apparatus and a finisher independent of the image forming apparatus on a network perform printing and finishing for a data file created by the application of the client PC.

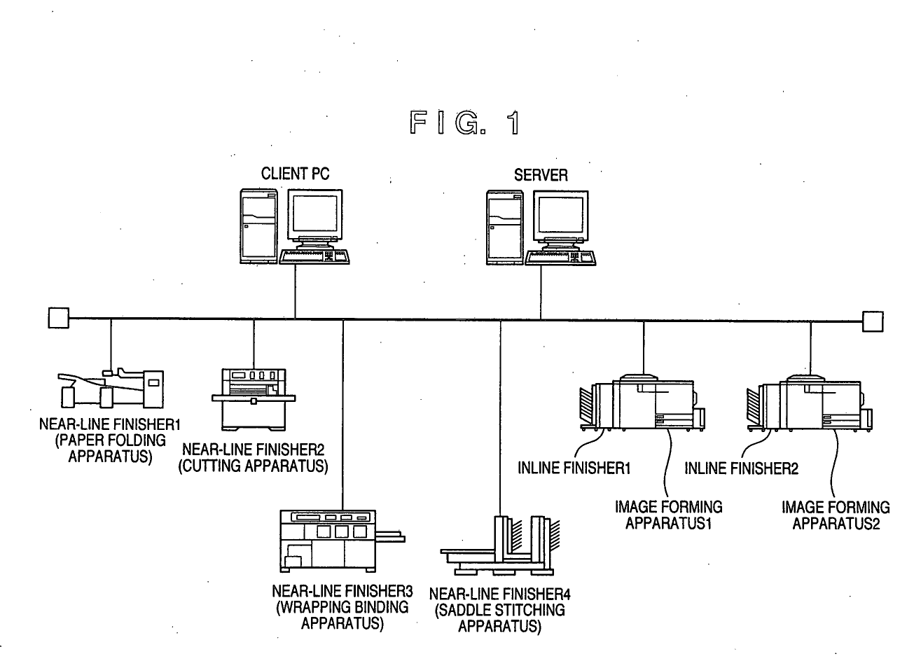

FIG. 1 is a view showing an example of a system configuration according to the first embodiment. As shown in FIG. 1, the system configuration includes a server, a client PC, an image forming apparatus 1, an inline finisher 1 connected in line to the image forming apparatus 1, an image forming apparatus 2 serving as another image forming apparatus, an inline finisher 2 connected in line to the image forming apparatus 2, and near-line finishers 1 (paper folding apparatus), 2 (cutting apparatus), 3 (wrapping binding apparatus), and 4 (saddle stitching bookbinding apparatus) connected to the client PC via a network. These components communicate with each other via the network.

Note that the terms “inline finisher”, “near-line finisher”, and “offline finisher” will be described below. These terms are distinguished and described in terms of a finisher processing method.

The “inline finisher” is a finisher which cannot singly communicate with a host computer and is connected to, e.g., an image forming apparatus via the same paper convey path. The contents of processing to be performed by the finisher for a printed product conveyed from the image forming apparatus are set from the inline-connected image forming apparatus. The processing contents are designated by post-processing setting information. A printing job containing designated processing contents (e.g., bookbinding processing) by the inline finisher can be generated by setting the inline finisher serving as the optional structure of the image forming apparatus using a printer driver which runs on the information processing apparatus.

The “near-line finisher” is a finisher which comprises a means for communicating with an external apparatus. The contents of processing to be performed by the finisher can be set from the finisher itself (operation unit or processing content read unit), and also set by inputting, e.g., processing contents (job ticket) from another device such as a host computer via the network. That is, unlike the inline finisher, the near-line finisher is a device independent of the image forming apparatus.

The “offline finisher” is a finisher which does not have any means for communicating with an external apparatus (offline), and the contents of processing to be performed by the finisher are set in the finisher itself. For example, the processing contents are set by the user from the operation unit of the offline finisher, or automatically set by reading printing information such as a barcode printed on paper to be subjected to post-processing.

The features will be described in terms of the convey path (paper path) of a printout product. These features are general ones and are described for easy understanding of the present invention, so the present invention is not limited to the following description.

The inline finishers 1 and 2 are physically connected to the respective image forming apparatuses. Paper printed out from the image forming apparatus is quickly sent to the finisher via the convey path (paper path). On the other hand, since the offline finisher is not physically connected to the image forming apparatus, paper printed out from the image forming apparatus is temporarily buffered on a truck, tray, belt conveyor, or the like, and then set at the input portion of the finisher. As for the near-line finishers 1 to 4, similar to the off-line finisher, printed paper is temporarily buffered and then set at the input portion of the near-line finisher. However, as described above, the near-line finisher can receive processing contents (job ticket) via the communication means. The inline finisher may also be equipped with a communication unit for communicating with the external device (host computer), receive a post-processing instruction (job ticket) via the communication unit, and operate as a near-line finisher.

<Structure of Server>

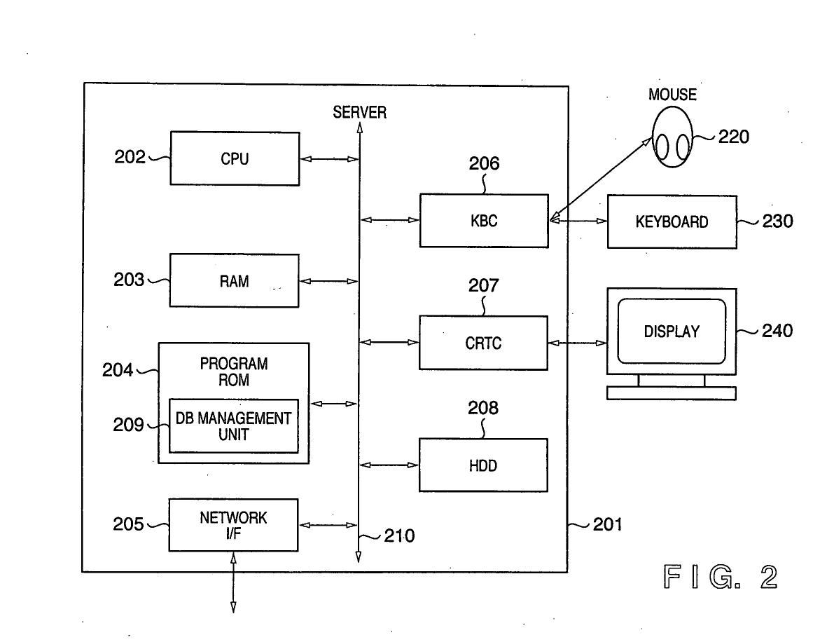

FIG. 2 is a block diagram showing an example of the structure of a server shown in FIG. 1. As shown in FIG. 2, a server 201 includes a CPU 202 which controls, based on a document processing program and the like stored in a program ROM 204 or a storage device 208 such as an HDD, a program and the like which include processing in each embodiment (to be described later in detail) and manage various pieces of device information. The CPU 202 generally controls the devices connected to a system bus 210.

The program ROM 204 or the storage device 208 such as the HDD includes a database (DB) management unit 209 for managing an operating system program (OS) serving as the control program of the CPU 202, and the device information on the network. A RAM 203 functions as the main memory and work area of the CPU 202.

A keyboard controller (KBC) 206 controls an input from a keyboard 230 or a pointing device such as a mouse 220. A CRT controller (CRTC) 207 controls display (including a copy-forgery-inhibited pattern image) on a CRT display (CRT) 240. A network I/F 205 is connected to various devices via the network to execute communication control processing.

The DB management unit 209 creates and manages a device management table containing a device ID and IP address, in order to use the functions of the devices such as the inline finisher and near-line finisher on the network. The device management table is stored in the storage device 208 such as the HDD, and changed by the DB management unit 209 as needed.

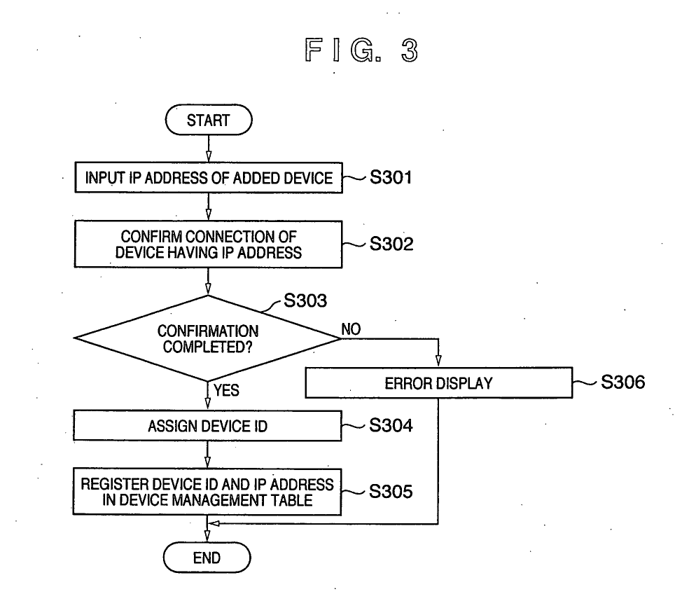

FIG. 3 is a flowchart showing device addition processing in the server 201. When a user connects a new device to the network, the IP address of the connected device is input with an input device such as the keyboard 230 (S301). The DB management unit 209 confirms whether the device having the input IP address is connected via the network I/F 205 (S302). Upon confirmation of connection (YES in S303), the DB management unit 209 assigns a device ID (S304). The device ID and the IP address are registered in the device management table (S305), and processing ends.

On the other hand, if the DB management unit 209 cannot confirm connection of the device (NO in S303), error display represents, on the CRT display 240, that the device having the IP address cannot be confirmed (S306), and processing ends.

Note that the device ID and IP address of the device information may be managed not only by the device management table of the server but also by the client PC or the image forming apparatus.

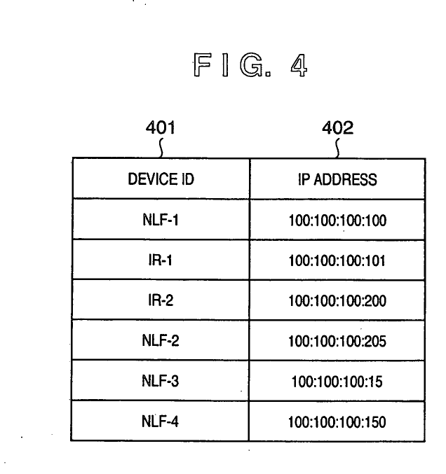

FIG. 4 is a table showing an example of the structure of the device management table. The device management table contains a device ID 401 unique to each device, and an IP address 402 on the network to which the device is connected.

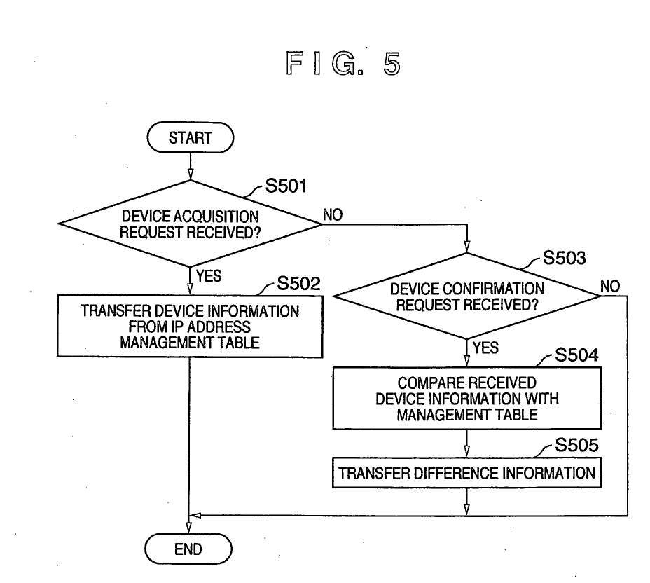

FIG. 5 is a flowchart showing processing of acquiring or confirming device information in the server 201. When the CPU 202 of the server 201 receives a device acquisition request from the device via the network I/F 205 (YES in S501), the device management table is read out from the storage device 208 to transfer the device ID and IP address from the device management table to the device which has issued the device acquisition request (S502).

When the CPU 202 does not receive the device acquisition request (NO in S501) but receives a device confirmation request (YES in S503), the CPU 202 compares the received device information with information in the device management table (S504). The difference information between them is transferred to the device which has issued the device confirmation request (S505).

<Structure of Client PC>

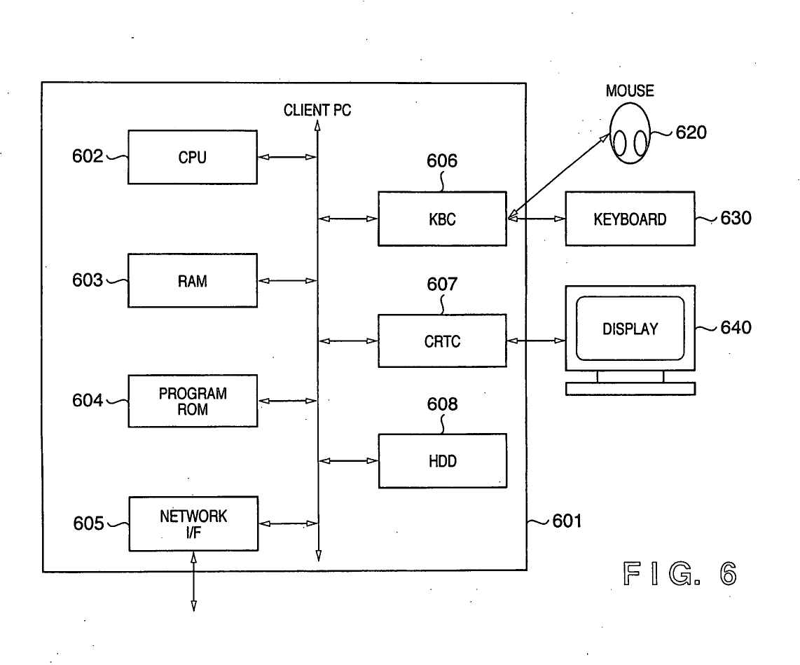

FIG. 6 is a block diagram showing an example of the structure of the client PC shown in FIG. 1. As shown in FIG. 6, a client PC 601 Includes a CPU 602 which controls to execute, based on a document processing program and the like In a program ROM 604 or a storage device 608 such as an HDD, document processing of a graphic, image, character, and table (including a spreadsheet) and printing processing based on such document processing including processes in each embodiment (to be described later in detail). The CPU 602 systematically controls the devices connected to the system bus.

The program ROM 604 or the storage device 608 such as the HDD stores an operating system program (OS) and the like serving as the control program of the CPU 602. A RAM 603 functions as the main memory and work area of the CPU 602.

A keyboard controller (KBC) 606 controls an input from a keyboard 630 or a pointing device such as a mouse 620. A CRT controller (CRTC) 607 controls display (including a copy-forgery-inhibited pattern image) on a CRT display (CRT) 640. A network I/F 605 is connected to the image forming apparatus via the network to execute communication control processing.

The mouse 620, keyboard 630G, and CRT display 640 of the client PC 601 are controlled by an application program and the printer driver (to be described later), and function as user interfaces (UIs) for causing a user to perform printing setting.

<General Description of Bookbinding Application>

In the client PC 601, the general description of a bookbinding application (the printing setting application of the present invention) for converting a data file created by a general application into an electronic document file by an electronic document writer, and editing the electronic document file with the bookbinding application will be explained below.

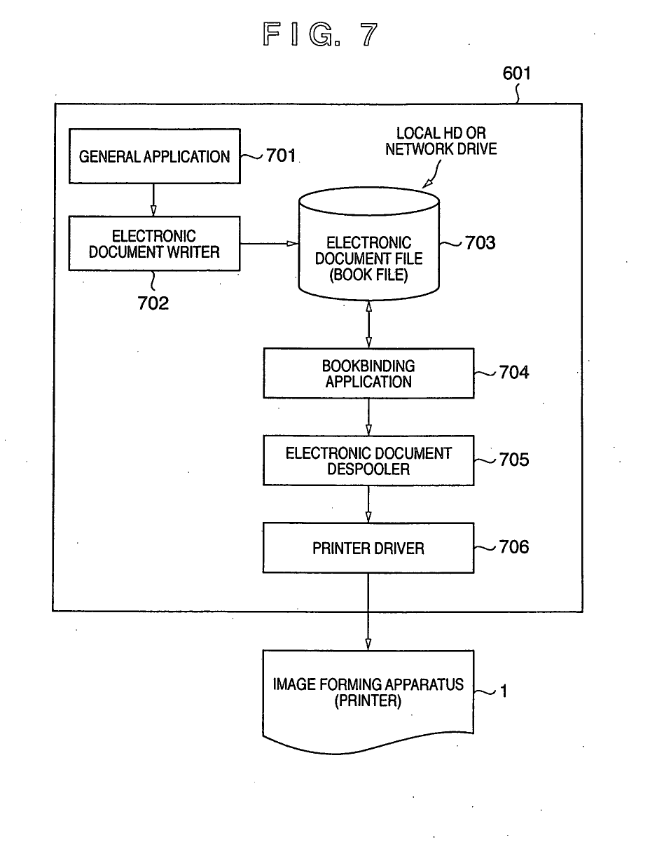

FIG. 7 is a block diagram showing a software architecture in the client PC 601. In FIG. 7, a general application 701 is an application program which provides functions such as wordprocessing, spreadsheet, photo-retouch, draw, paint, presentation, and text editing. The general application 701 has a printing function corresponding to the OS. Such applications utilize a predetermined interface (generally called GDI) provided by the OS in printing application data such as created document data or image data.

To print the created data file using an output device, the general application 701 transmits an output command (GDI (Graphic Device Interface) function) which is determined in advance for the output module of the OS providing the interface and has an OS-dependent format. The output module which has received the output command converts the command into a format processible by an output device such as an image forming apparatus, and outputs the converted command (DDI (Device Driver Interface) function). Since the format processible by the output device changes based on the type of device, the manufacturer, and the model, a device driver is provided for each device. The OS converts a command by using the device driver, generates printing data, and combines printing data by JL (Job Language) to generate a printing job.

When the OS is Microsoft Windows®, the output module is a GDI module.

An electronic document writer 702 is the improved software module of the above-mentioned device drivers. The electronic document writer 702 does not target a specific output device, and converts an output command into a format processible by a bookbinding application 704 or printer driver 706 (to be described later).

The format (to be referred to as an “electronic document format” hereinafter) converted by the electronic document writer 702 is not particularly limited as far as each document page can be expressed by a detailed format. Of substantial standard formats, for example, the PDF format by Adobe Systems and the SVG format can be adopted as electronic document formats. When the application 701 utilizes the electronic document writer 702, the electronic document writer 702 is designated as a device driver used for output, and then caused to execute printing.

An electronic document file created by the electronic document writer 702 does not have a complete electronic document file format. For this reason, the electronic document writer 702 is designated as a device driver by the bookbinding application 704, and executes conversion of application data into an electronic document file 703 under the management of the bookbinding application 704.

The bookbinding application 704 completes a new incomplete electronic document file generated by the electronic document writer 702 as an electronic document file 703 having the following format. In case of necessity to definitely discriminate these files, a file created by the electronic document writer 702 will be called the electronic document file 703, and the electronic document file 703 given a structure by the bookbinding application 704 will be called a book file. If these files need not be particularly discriminated, a document file generated by the general application 701, an electronic document file, and a book file are called document files (or document data).

As described above, the electronic document writer 702 is designated as a device driver, and the general application 701 prints the data. Application data is converted into an electronic document format in pages (to be referred to as “logical pages” or “document pages” hereinafter) defined by the application 701. The converted data is stored as an electronic document file 703 in a storage medium such as an HDD.

The hard disk may be the local drive of the client PC 601 in the first embodiment, or when the client PC 601 is connected to a network, may be a drive provided on the network.

The bookbinding application 704 provides the user with a function of loading and editing the electronic document file (book file) 703. The bookbinding application 704 provides no function of editing the contents of each page, but a function of editing a chapter or book structure (to be described later) made up of pages as a minimum unit.

To print the book file 703 edited by the bookbinding application 704, the bookbinding application 704 activates an electronic document despooler 705. The electronic document despooler 705 is a program module installed into the computer together with the bookbinding application 704. The electronic document despooler 705 is a module used to output drawing data to a printer driver 706 in printing a document (book file) used by the bookbinding application 704.

The electronic document despooler 705 reads out a designated book file from the hard disk. To print each page in a format described in the book file, the electronic document despooler 705 generates an output command complying with the output module of the OS described above, and outputs the command to the output module (not shown). At this time, the driver of the image forming apparatus used as an output device is designated as a device driver (the printer driver 706 shown in FIG. 7). The output module converts the output command received using the designated printer driver 706 of the image forming apparatus 1 into a device command interpretable by the image forming apparatus 1. The device command is transmitted to the image forming apparatus 1 via the network, and an image corresponding to the command is then printed by the image forming apparatus 1.

<Electronic Document File Format>

Before the bookbinding application 704 is described in detail, the book file data format will be explained. The book file has a three-layered structure similar to a paper-medium book. The upper layer is called a “book”, resembles one book, and defines the attributes of the entire book. The intermediate layer corresponds to a chapter in the book, and is also called a “chapter”. As for each chapter, its attributes can be defined. The lower layer is a “page”, and corresponds to each page defined by an application program. As for each page, its attributes can be defined. One book may include a plurality of chapters, and one chapter may include a plurality of pages.

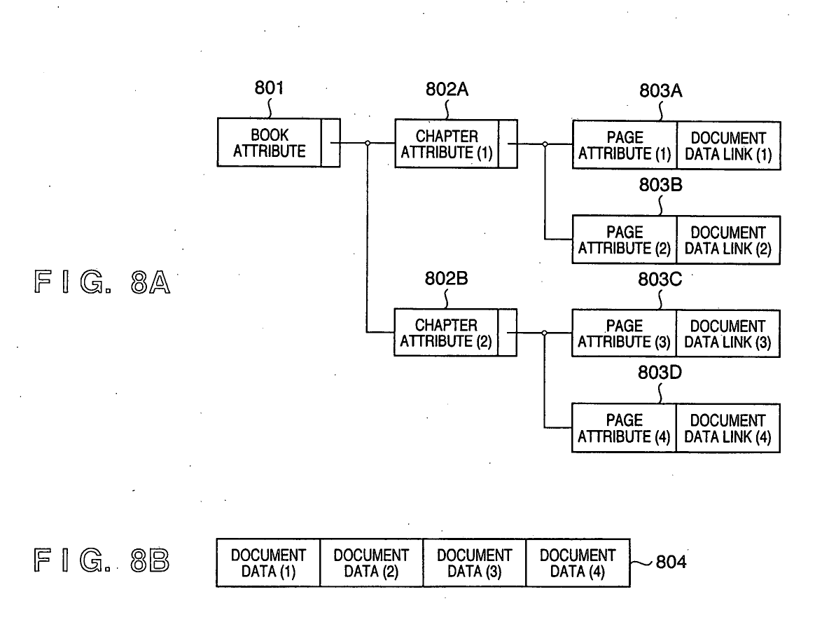

FIG. 8A is a block diagram schematically showing an example of the book file format. In the book file of this example, a book, chapter, and page are represented by corresponding nodes. One book file includes one book. The book and chapter are a concept for defining a book structure, and contain, as entities, defined attribute values and links to lower layers. The page has, as an entity, data of each page output from an application program. In addition to an attribute value, the page contains the entity of a document page (document page data) and a link to each document page data.

In some cases, a print page to be output onto a paper medium or the like includes a plurality of document pages. This structure is displayed not by a link but by an attribute in the book, chapter, or page layer.

In FIGS. 8A and 8B, a book 801 defines a book attribute, and is linked to two chapters 802A and 802B. These links display that the chapters 802A and 802B are included in the book 801. The chapter 802A is linked to pages 803A and 803B, which represents that the chapter 802A includes these pages. The pages 803A and 803B define attribute values, and contain links to document page data (1) and (2) serving as entities. These links represent data (1) and (2) of document page data 804 shown in FIG. 8B, and display that the entities of the pages 803A and 803B are document page data (1) and (2).

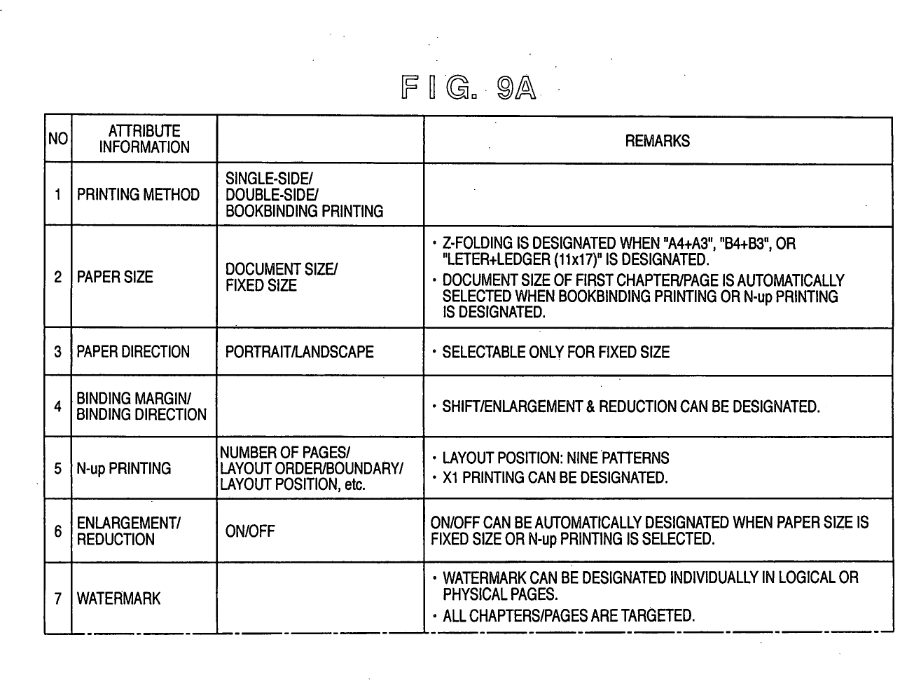

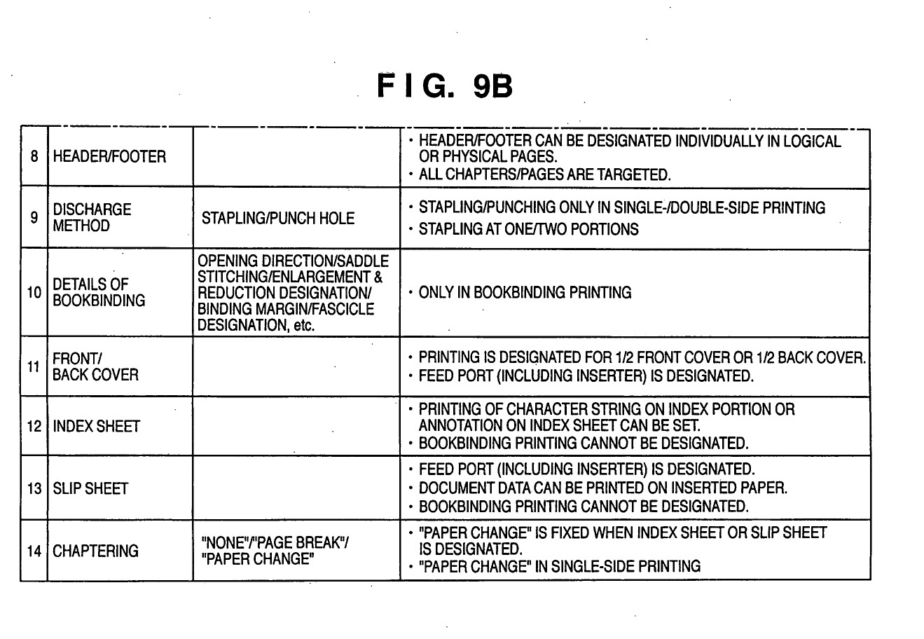

FIGS. 9A and 9B are tables showing a list of book attributes. As for an item which can be defined repetitively on a lower layer, the attribute value of the lower layer is preferentially adopted. As for an item contained in only the book attribute, a value defined in the book attribute is effective over the book. An item repetitively defined on a lower layer is a default value used when this item is not defined in the lower layer. Each item shown in FIGS. 9A and 9B does not correspond to one concrete item, but may contain a plurality of relevant items.

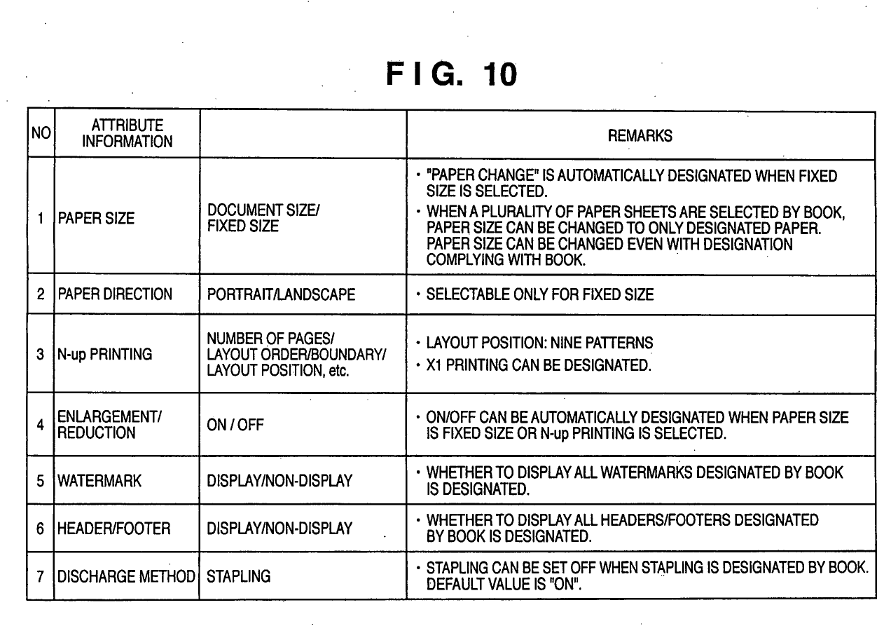

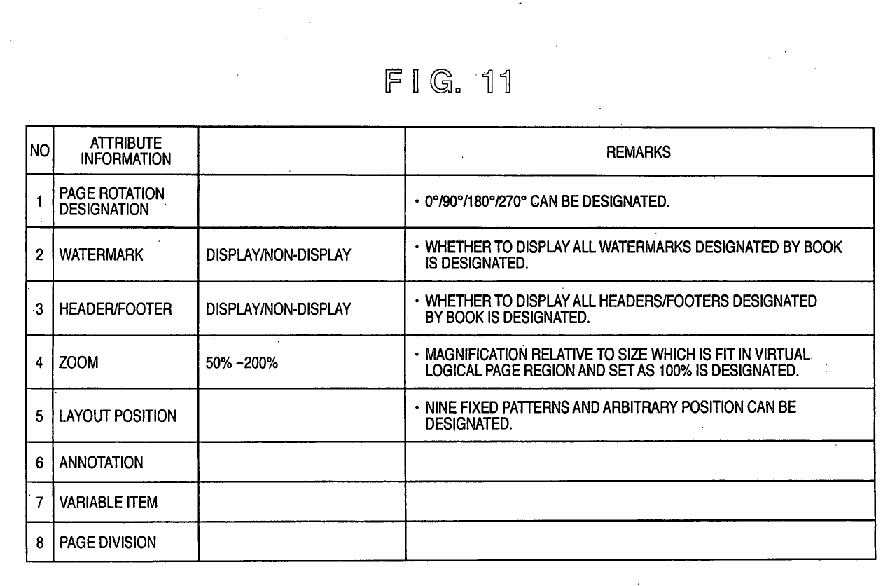

FIG. 10 is a table showing a list of chapter attributes, and FIG. 11 is a table showing a list of page attributes. The relationship between chapter attributes and page attributes is the same as that between book attributes and lower layer attributes.

As shown in FIGS. 9A and 9B, items unique to book attributes are six items: printing method, details of bookbinding, front/back cover, index sheet, slip sheet, and chaptering. These items are defined over the book. As printing method attributes, three values: single-side printing, double-side printing, and bookbinding printing can be designated. Bookbinding printing is a method of printing data in a format which allows bookbinding by bundling a separately designated number of paper sheets, folding the bundle into two, and binding the bundle. As detailed bookbinding attributes, the opening direction and the number of paper sheets to be bundled can be designated when bookbinding printing is designated.

The front/back cover attribute includes designation of adding paper sheets serving as front and back covers when an electronic document file combined as a book is printed, and designation of contents to be printed on the added paper sheets. The index sheet attribute includes designation of inserting a tabbed index sheet separately prepared in a printing apparatus for chaptering, and designation of contents to be printed on the index (tabbed) portion. This attribute becomes effective when a printing apparatus to be used is equipped with an inserter having an inserting function of inserting a paper sheet prepared separately from a print paper sheet into a desired position, or when a plurality of sheet cassettes can be used. This also applies to the slip sheet attribute.

The slip sheet attribute includes designation of inserting a paper sheet fed from an inserter or sheet feed cassette for chaptering, and designation of a sheet feed source when a slip sheet is inserted.

The chaptering attribute includes designation of whether to use a new paper sheet, use a new print page, or do nothing particular at a chapter break. In single-side printing, the use of a new paper sheet and the use of a new print page are the same. In double-side printing, a continuous chapter is not printed on one paper sheet if “the use of a new paper sheet” is designated, but may be printed on the obverse and reverse of one paper sheet if “the use of a new print page” is designated.

As for the chapter attribute, there is no item unique to the chapter, and all items overlap those of the book attribute. If the definition of the chapter attribute is different from that of the book attribute, a value defined by the chapter attribute precedes. Items common to only the book and chapter attributes are five items: paper size, paper direction, N-up printing designation, enlargement/reduction, and discharge method. The N-up printing designation attribute is an item for designating the number of document pages included in one print page. Layouts which can be designated are 1×1, 1×2, 2×2, 3×3, 4×4, and the like. The discharge method attribute is an item for designating whether to staple discharged paper sheets. The effectiveness of this attribute depends on whether the printing apparatus has a stapling function.

Items unique to the page attribute are a page rotation attribute, zoom, layout designation, annotation, and page division. The page rotation attribute is an item for designating the rotation angle when a document page is laid out on a print page. The zoom attribute is an item for designating the zoom ratio of a document page. The zoom ratio is designated based on a virtual logical page region size=100%. The virtual logical page region is a region occupied by one document page when document pages are laid out in accordance with N-up designation or the like. For example, the virtual logical page region is a region corresponding to one print page for 1×1, and a region obtained by reducing each side of one print page to about 70% for 1×2.

Attributes common to the book, chapter, and page are a watermark attribute and header/footer attribute. The watermark is a separately designated image or character string printed over data created by an application. The header and footer are watermarks printed at the upper and lower margins of each page. For the header and footer, items such as a page number, and time and date which can be designated by variables are prepared.

Contents which can be designated by the watermark attribute and header/footer attribute are common to the chapter and page, but are different in the book. The book can set the contents of the watermark and header/footer, and designate how to print a watermark or header/footer throughout the book. To the contrary, the chapter and page can designate whether to print a watermark or header/footer set by the book on the chapter or page.

<Book File Generation Procedures>

The book file has the above-described structure and contents. Procedures of creating a book file by the bookbinding application 704 and electronic document writer 702 will be explained. Creation of a book file is realized as part of book file editing operation by the bookbinding application 704.

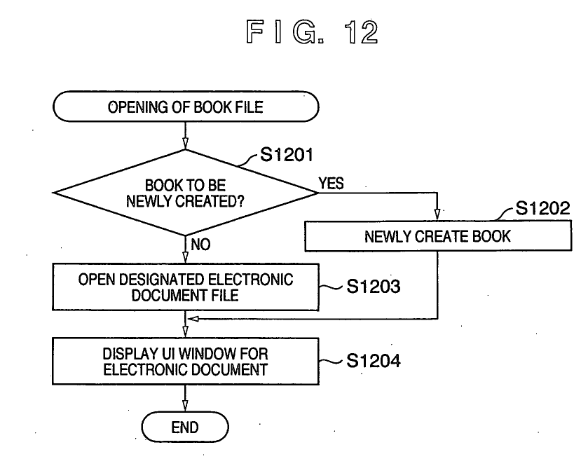

FIG. 12 is a flowchart showing procedures when the bookbinding application 704 opens a book file. The bookbinding application 704 checks whether a book file to be opened is one to be newly created or an existing one (step S1201). If YES in step S1201, the bookbinding application 704 newly creates a book file including no chapter (step S1202). In the example shown in FIGS. 8A and 8B, the newly created book file is a book node which has only the book node 801 without any link to a chapter node. As the book attribute, a set of attributes prepared in advance for creation of a new book file are applied. The bookbinding application 704 then displays a user interface (UI) window for editing the new book file (step S1204).

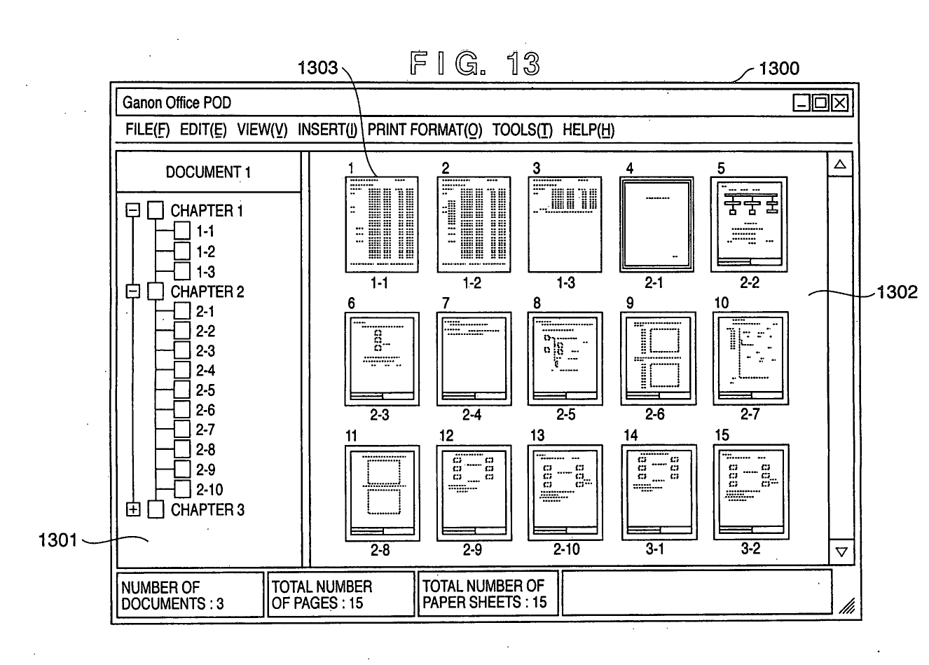

If NO in step S1201, the bookbinding application 704 opens a designated book file (step S1203), and displays a user interface (UI) window in accordance with the structure, attribute, and contents of the book file. FIG. 13 shows an example of the user interface (UI) window. The UI window 1300 has a tree portion 1301 representing a book structure, and a preview portion 1302 displaying a state to be printed. The tree portion 1301 displays chapters included in the book and pages included in each chapter by a tree structure as shown in FIG. 8A. Pages displayed at the tree portion 1301 are document pages. The preview portion 1302 displays reduced print page contents. The display order reflects the book structure.

In the opened book file, the application data converted into the electronic document file by the electronic document writer 702 can be added as a new chapter. This function is called an electronic document import function. The electronic document is imported to the book file which is newly created by the procedures of FIG. 12, thereby giving an entity to this book file.

<Editing of Book File>

As described above, a book file can be created from the general application data 701. The generated book file allows editing a chapter and page as follows.
(1) New document
(2) Delete
(3) Document
(4) Cut
(5) Paste
(6) Move
(7) Change chapter name
(8) Reassign page number/name
(9) Insert cover
(10) Insert slip sheet
(11) Insert index sheet
(12) Page layout of each document page

In addition, an operation of canceling executed editing operation, and an operation of restoring canceled operation can be performed. These editing functions enable editing operations such as consolidation of a plurality of book files, reconfiguration of chapters and pages within a book file, delete of chapters and pages within a book file, layout change of a document page, and insertion of a slip sheet and index sheet. By these operations, operation results are reflected in attributes shown in FIGS. 9 to 11 or on a book file structure. For example, a blank page is inserted into a designated portion by an operation of newly adding a blank page. The blank page is processed as a document page. If the layout of a document page is changed, the change contents are reflected in attributes such as the printing method, N-up printing, front/back cover, index sheet, slip sheet, and chaptering.

<Output of Book File>

The ultimate goal of a book file created and edited in the above manner is to print it out. The user selects a file menu from the UI window 1300 of the bookbinding application shown in FIG. 13, and selects printing from the displayed pull down menu. The book file is then printed out from a designated output device. At this time, the bookbinding application 704 creates a job ticket from a currently open book file, and transfers the job ticket to the electronic document despooler 705. As a result, the electronic document despooler 705 converts the job ticket into an OS output command, e.g., a GDI command, and transmits the command to an output module, e.g., GDI.

The output module generates a command complying with a device by a designated printer driver 706, and transmits the command to the device.

The job ticket is data with a structure whose minimum unit is a document page. The structure of the job ticket defines the layout of a document page on paper. One job ticket is issued for one job. A document node is set at the top of the structure, and defines the attribute of the whole document such as double-side printing/single-side printing. A paper node belongs to the document node, and contains attributes such as the identifier of paper for use and designation of a feed port in the printer. A sheet node to be printed on the paper belongs to each paper node. One sheet corresponds to one paper sheet. A print page (physical page) belongs to each sheet. One physical page belongs to one sheet for single-side printing, and two physical pages belong to one sheet for double-side printing. A document page to be laid out on a physical page belongs to the physical page. The physical page attribute contains a document page layout.

The electronic document despooler 705 converts the job ticket into an output command to the output module.

<Structure of Image Forming Apparatus>

The structure of the image forming apparatus which receives a printing command output from the printer driver 706 in the client PC 601, and performs printing processing will be described below.

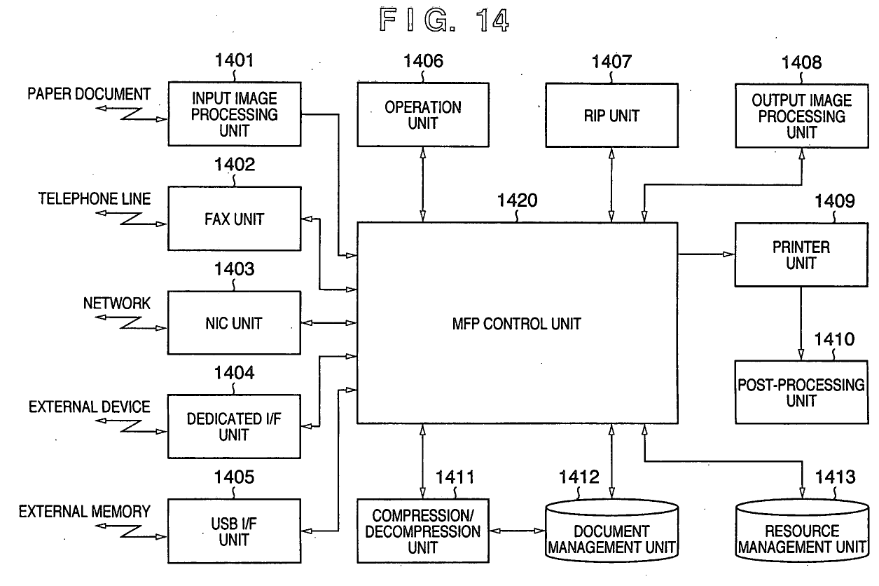

FIG. 14 is a block diagram showing an example of the structure of the image forming apparatus shown in FIG. 1. As shown in FIG. 14, the image forming apparatus includes an input image processing unit 1401 which reads a document image using a scanner, processes the read image, and outputs the processed image as image data, a FAX unit 1402 which is represented by a facsimile apparatus and transmits/receives an image by using a telephone line, a NIC (Network Interface Card) unit 1403 which exchanges image data and apparatus information via a network, a dedicated I/F unit 1404 which exchanges information with the image forming apparatus, a USB I/F unit 1405 which exchanges serial data with an external memory or the like, an operation unit 1406, a raster image processor (RIP) unit 1407, an output image processing unit 1408, a printer unit 1409, a post-processing unit 1410, a compression/decompression unit 1411, a document management unit 1412, and a resource management unit 1413. In accordance with the use mode of the printer, an MFP control unit 1420 controls to, for example, temporarily save an image signal or determine a path.

Note that the image forming apparatus includes a memory such as a hard disk which can store a plurality of image data. For example, the control unit (for example, the CPU of the MFP control unit 1420) in the image forming apparatus mainly controls the following various image data to be stored in this hard disk. For example, the image data include the image data from the input image processing unit 1401, image data of a facsimile job which is input via the FAX unit 1402, image data input from an external apparatus (for example, a computer) via the NIC unit 1403, and image data input from another image forming apparatus via the I/F unit 1404. Then, the control unit properly reads out the image data from this hard disk, transfers the readout image data to an output unit such as the printer unit 1409, and controls to execute output processing such as printing processing by the printer unit 1409. The control unit also receives an instruction from the operator via the operation unit 1406, and controls to transfer the image data read out from the hard disk, to an external apparatus such as a computer or another image forming apparatus.

<Structure of Near-Line Finisher>

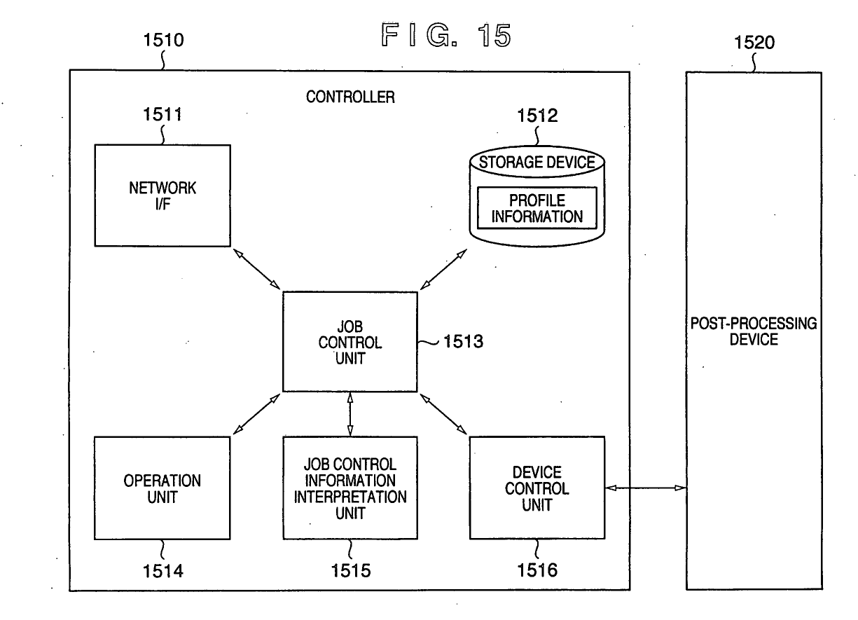

Of various types of finishers, an example of the internal structure of the near-line finisher shown in FIG. 1 will be described with reference to FIG. 15.

As shown in FIG. 15, the near-line finisher comprises a post-processing device 1520 and a controller 1510 which controls the post-processing device 1520. In the controller 1510, reference numeral 1511 denotes a network I/F which communicates with another network device such as a host computer or MFP. Reference numeral 1512 denotes a primary storage device (e.g., DRAM) or a secondary storage device (e.g., HDD) which temporarily saves information.

Reference numeral 1513 denotes a job control unit which controls a job in a near-line finisher. Reference numeral 1514 denotes an operation unit which accepts an ID input from the user. Reference numeral 1515 denotes a job control information interpretation unit which interprets input job control information (called job ticket) and converts it into a format capable of controlling a device. Reference numeral 1516 denotes a device control unit which controls the post-processing device 1520.

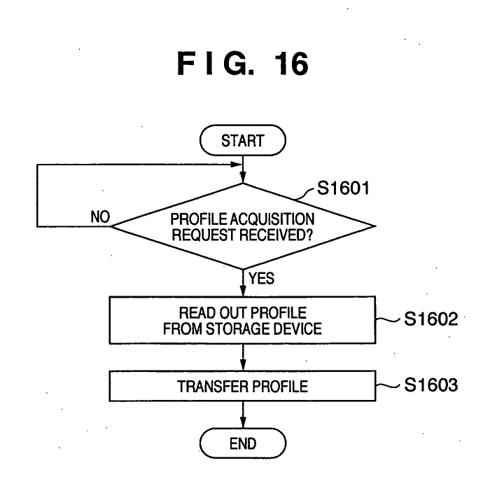

FIG. 16 is a flowchart showing finisher profile transfer processing of the near-line finisher shown in FIG. 15. When the job control unit 1513 receives a finisher profile acquisition request from a device such as the image forming apparatus, server, or client PC via the network I/F 1511 (YES in S1601), the profile information is read out from the storage device 1512 (S1602). The profile information is then transferred to the device which has issued the acquisition request (S1603). Note that the profile information will be described later in “Internal structure of Profile”.

[Internal Structure of Profile]

In the first embodiment, a finisher profile is described in the XML format. As described above, finishers vary in type such as a bookbinding apparatus, cutting apparatus, and folding apparatus, and the functions of respective types are different from each other. Information greatly changes upon, e.g., adding a new function. In order to properly cope with these finishers, the profile is described using XML in a tag format. As a matter of course, the profile can be described in any format as far as addition of a new function and the like can be adaptively described.

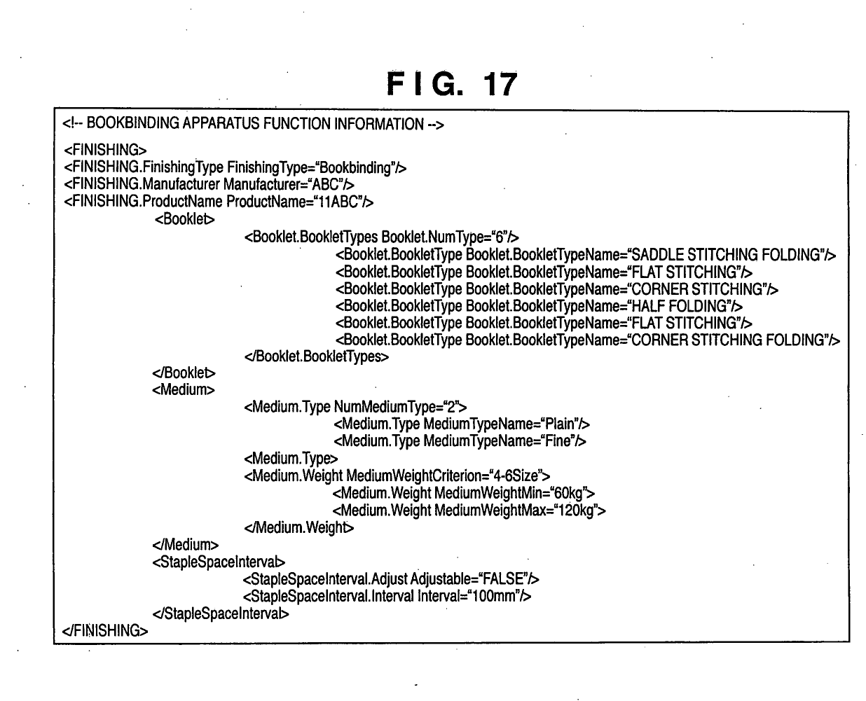

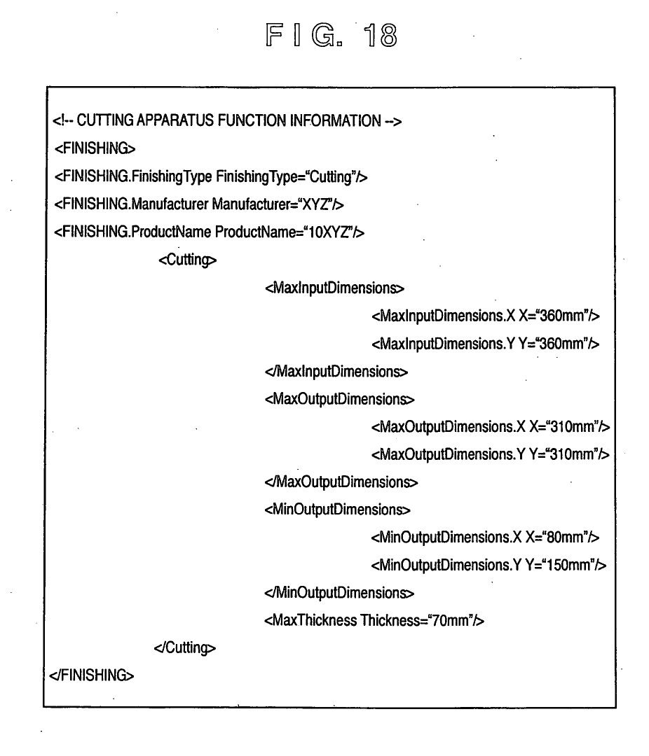

FIG. 17 is a view showing an example of describing the finisher profile of a bookbinding apparatus, and FIG. 18 is a view showing an example of describing the finisher profile of a cutting apparatus. In FIG. 17, “FinishingType” represents a type such as a bookbinding apparatus or cutting apparatus, “Manufacturer” represents a manufacturer name, and “ProductName” represents a model. FIG. 17 shows “bookbinding apparatus of 11ABC model available from ABC (Type: Bookbinding)”.

FIG. 18 shows “cutting apparatus of 10XYZ model available from XYZ (Type: Cutting)”. Tags “booklet” in FIG. 17 and “Cutting” in FIG. 18 describe functions unique to the bookbinding apparatus and cutting apparatus. In this manner, a function unique to each finisher can be individually defined by a tag and described as a profile.

For example, the “Booklet” tag of the bookbinding apparatus in FIG. 17 defines type names “saddle stitching folding”, “flat stitching”, “corner stitching”, “half folding”, “flat stitching folding”, and “corner stitching folding”. The “Medium” tag defines medium types “Plain” and “Fine”, and medium weights “60 kg” as a minimum value and “120 kg” as a maximum value. The “StapleSpaceInterval” tag defines that the-staple interval cannot be adjusted (“False”) and the interval is 100 mm.

In FIG. 18, the “Cutting” tag describes that the maximum input dimensions (MaxInputDimensions) are 360 mm in breadth and length (X,Y). Also, the “Cutting” tag describes that the maximum output dimensions (MaxOutputDimensions) are 310 mm in breadth and length (X,Y), the minimum output dimensions (MinOutputDimensions) are 80 mm in breadth (X) and 150 mm in length (Y). Further, the “Cutting” tag describes that the maximum thickness (MaxThickness) is 70 mm.

In this way, finisher profile information defines the type (kind) of function, the manufacturer name, the model name, and the performance (e.g., dimensions and binding position) of each function. The profile information may be saved in, e.g., the storage device 2101 of the finisher, and read out and collected by the image forming apparatus, or directly collected from the near-line finisher under the control of the printer driver of an information processing apparatus serving as a host computer.

<Printing Setting and Finisher Setting>

The processing operation of printing setting and finisher setting performed by the bookbinding application 704 will be described below.

The above-described bookbinding application 704 can perform printing setting and finisher setting for the document data in the electronic document file within the range of functions available in a specific image forming apparatus, and freely perform printing setting and finisher setting regardless of the function of the specific image forming apparatus. The former is called a function limitation mode, and the latter is called a function non-limitation mode hereinafter.

Assume that a document creator creates a document by performing printing processing using a specific image forming apparatus (printer) available in a document creation environment, and performing finishing processes such as bookbinding, cutting, and paper folding using the inline finisher or near-line finisher. In this case, since the document is created in the function limitation mode, printing setting and finisher setting can be performed for the document within the range of functions available in the specific printer and finisher.

On the other hand, assume that the document creator creates a document by performing printing processing using a printer unavailable in the document creation environment, or using an arbitrary printer to be used for printing. In this case, since the document is created in the function non-limitation mode, high-performance printing setting can be performed for the document even in the environment without any high-performance printer.

In the system according to this embodiment, the capability can be acquired, and the setting value can be acquired and set not only within the range of basic functions recognized by the OS, but also within the range of printer and finisher functions such as stapling, saddle stitching, and Z-folding which are not generally recognized by the current OS.

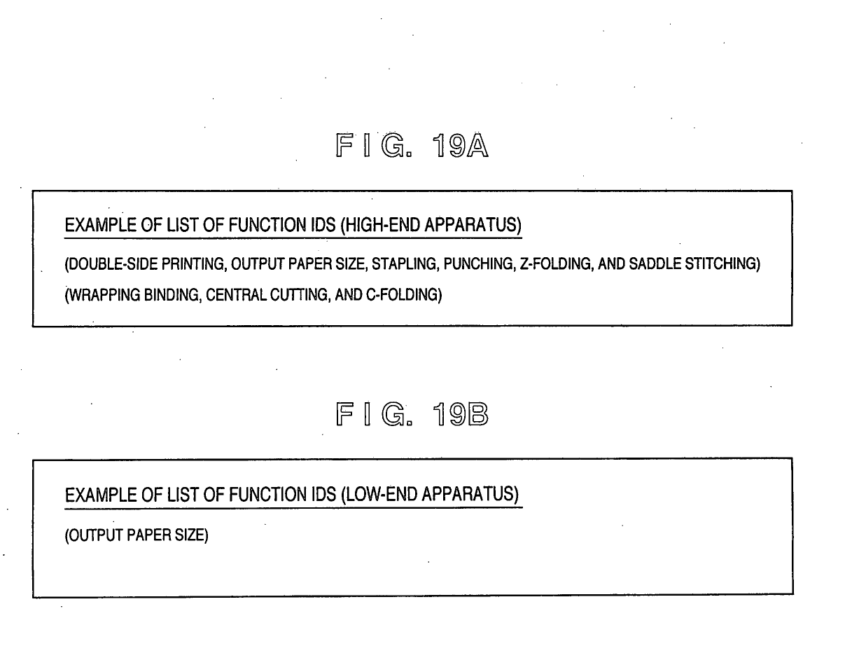

FIGS. 19A and 19B are views showing examples of pieces of function information acquired from a printer driver 706 by a bookbinding application 704. When the bookbinding application 704 inquires of the printer driver 706 about a controllable function, the printer driver 706 sends back the ID list of controllable functions as shown in FIGS. 19A and 19B.

In the example of a high-performance device shown in FIG. 19A, the printer driver 706 sends back a list indicating that the printer and inline finisher can control double-side printing, output paper size, stapling, punching, Z-folding, saddle stitching, wrapping binding, central cutting, and C-folding. On the other hand, in the example of a low-performance device shown in FIG. 19B, the printer does not have the inline finisher, and can control only output paper size.

As described above, since the printer driver 706 is dedicated for a specific printer, the printer driver 706 has information representing, e.g., whether each function can be controlled. Such information is sent back in response to the inquiry from the application.

Furthermore, the bookbinding application 704 can acquire, from the printer driver 706, the current setting value, change in setting value, range of setting values, list of settable choices, and the like of the listed functions.

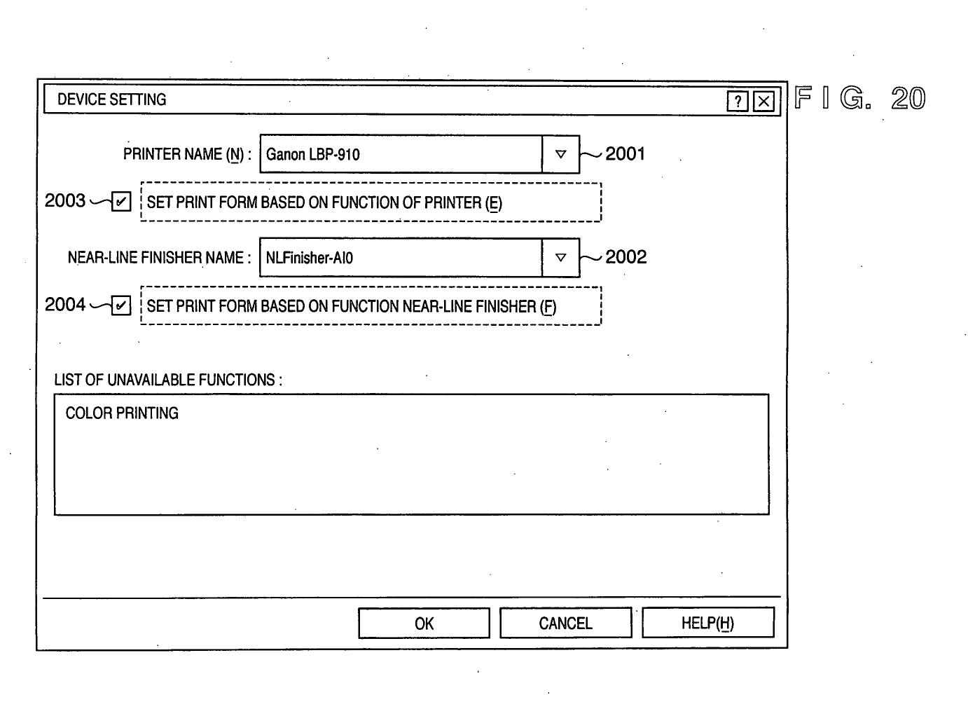

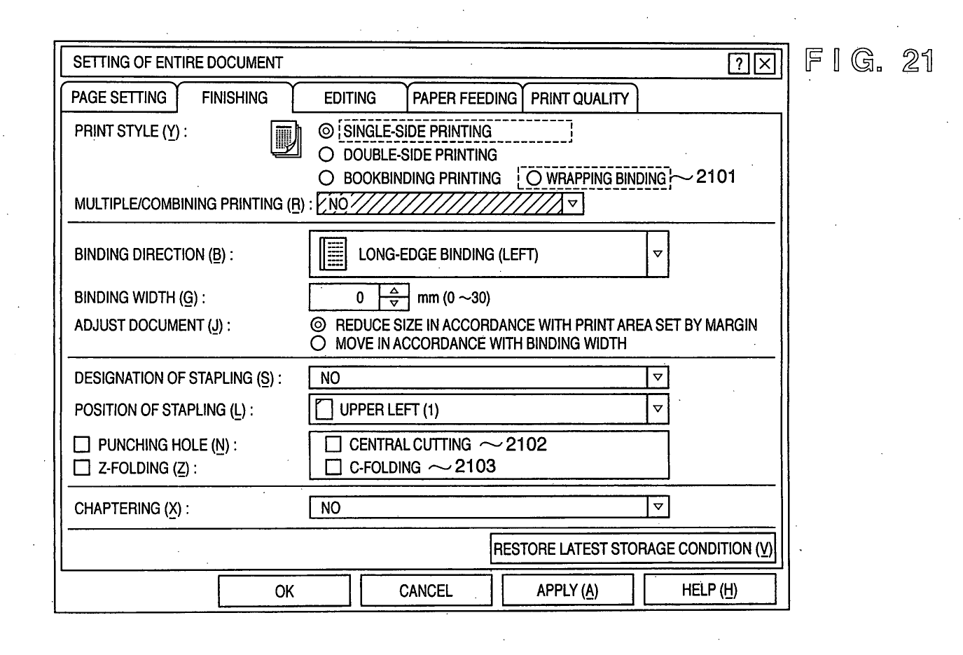

FIG. 20 is a view showing a device selection window in the bookbinding application 704. As shown in FIG. 20, the user can select a printer upon clicking a pull down menu 2001, and select a near-line finisher upon clicking a pull down menu 2002.

Also, when the check boxes of “set print form for the function of the printer” 2003 and “set print form for the function of the near-line finisher” 2004 are checked, as shown in FIG. 21, printing setting items corresponding to the checked items are added on a finishing window in setting an entire document.

FIG. 21 is a view showing an example of a setting window when a near-line finisher is selected. In the example shown in FIG. 21, when the near-line finisher selected on the selection window in FIG. 20 has the functions of wrapping binding 2101, central cutting 2102, and C-folding 2103, the printing setting items corresponding to these functions are additionally displayed on this setting window.

<Printing Processing in Client PC>

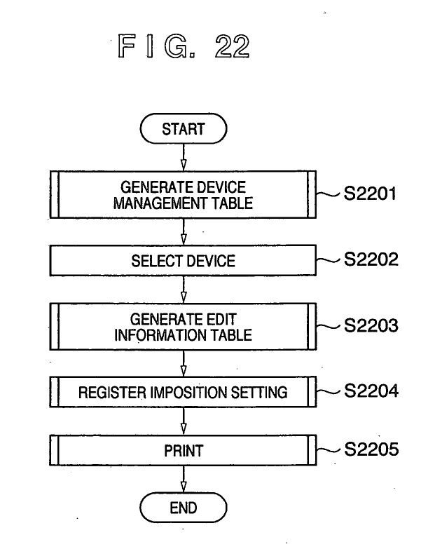

FIG. 22 is a flowchart showing sequential processing in the client PC 601. In the client PC 601, the operator activates the bookbinding application 704 to open document data in the electronic document file 703. Accordingly, the bookbinding application 704 generates pieces of device information of the image forming apparatus 1, inline finishers 1 and 2, near-line finishers 1 to 4, and the like on the network (S2201). The operator then selects a desired device based on the device information displayed on the device selection window in FIG. 20 (S2202) to generate the edit information table of the selected device (S2203). The edit information table will be described later. The bookbinding application 704 allows the operator to set, to the document data, a function which can be implemented based on the selected device information. In accordance with the operator's operation, page editing processing such as imposition setting is performed for the document data (S2204), and printing processing is executed after confirming the edit result on the UI (S2205).

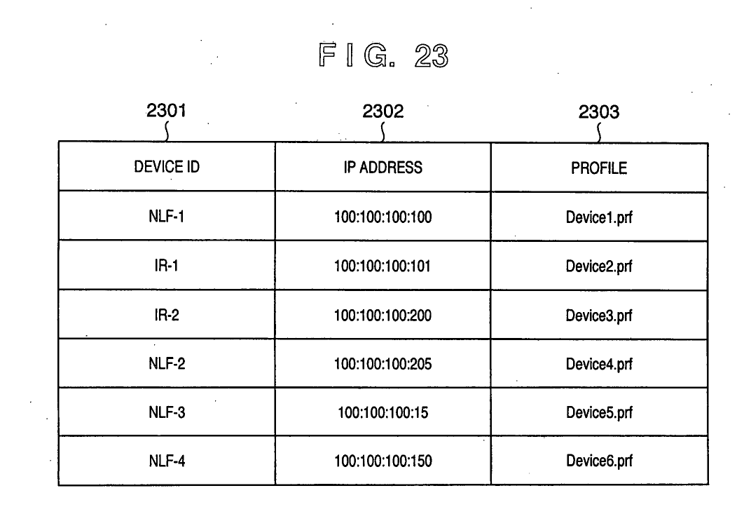

FIG. 23 is a table showing an example of the device management table for managing device information in the client PC 601. As shown in FIG. 23, the device management table contains-a device ID 2301, an IP address 2302 serving as the address of a device having the device ID 2301 on the network, and a name 2303 of the file which stores the profile of the device.

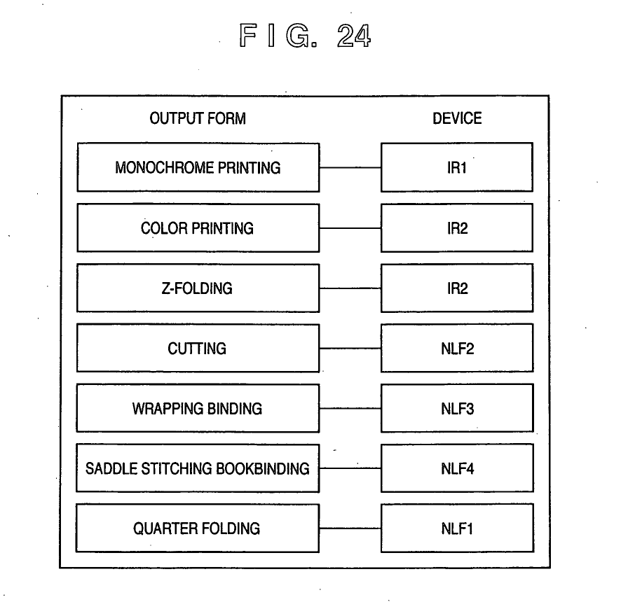

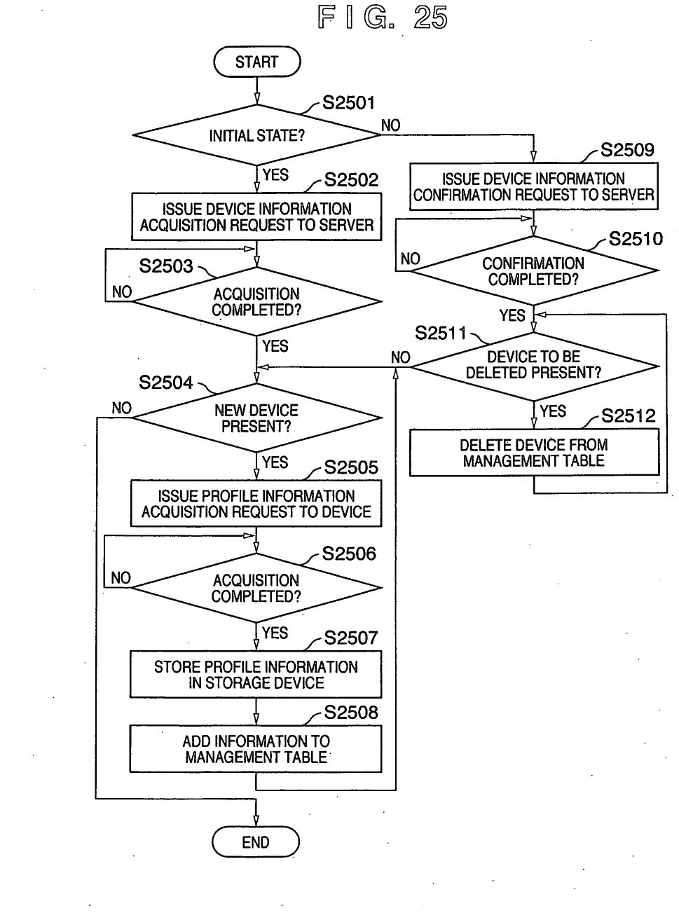

FIG. 24 is a view showing, as one of edit information tables, an example of an output form table for managing a device for each output form by the client PC 601. In this example, the output forms are classified into, e.g., printing, bookbinding, folding, and cutting to manage a device (see FIG. 1) having a function corresponding to each output form. For example, when monochromatic printing is selected as the output form, a device IR1 corresponds to the function of monochromatic printing. When color printing is selected, a device IR2 corresponds to the function of color printing. Note that a device need not be uniquely correspond to each output form. For example, in monochromatic printing, the devices IR1 and IR2 may correspond to the function of monochromatic printing.

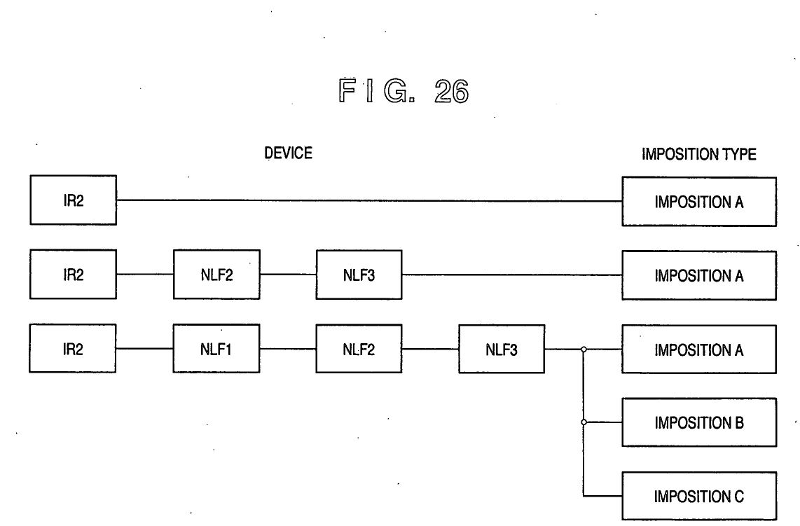

FIG. 25 is a flowchart showing detailed procedures in device management table generation processing (S2201) shown in FIG. 22. The bookbinding application 704 determines whether the device is in an initial state based on whether the device management table has been stored in the file for page editing (S2501). If no device management table has been stored and the device is in the initial state, the bookbinding application 704 issues a device information acquisition request to the server 201 on the network via the network I/F 605 (S2502), and waits for the device information (S2503). After that, upon acquisition of the device information, the bookbinding application 704 determines whether a new device is connected on the network (S2504). If the new device is connected, the bookbinding application 704 issues a profile information acquisition request to the device (the image forming apparatus or the near-line finisher) having the IP address of the acquired device information (S2505). Upon acquisition of the profile information (YES in S2506), the acquired profile information is stored in the file (S2507), and the device ID 2301, the IP address 2302, and the file name 2303 of the profile information are added to the device management table (S2508).

On the other hand, if the device management table has already been stored, and the device is not in the initial state, the bookbinding application 704 issues a request to the server 201 to confirm whether an existing device or new device is connected to the network (S2509), and waits for the device information (S2510). After that, upon acquisition of the device information, the device information stored in the device management table is compared with the acquired device information to determine whether a device has been disconnected from the network. If it is determined that the device has been disconnected (YES in S2511), the bookbinding application 704 deletes, from the device management table, the device information of the separated device (S2512). If a new device is connected, in S2504 to S2508, the device information of the new device is added to the device management table. Finally, the output form table shown in FIG. 24 is generated by all profile information, and processing ends.

FIG. 26 is a view showing, as one of edit information tables, an example of an imposition edit table for managing an imposition method available by combining devices by the client PC 601. In this imposition edit table, all types of imposition settings available by combining the selected devices are set. For example, when the printing apparatus (IR2) has an N-up function (a print layout in which a plurality of logical pages are arranged on one physical paper sheet), the imposition type is N-up imposition (imposition A). However, when it is designated that the printing apparatus (IR2) is used in combination with post-processing devices (NLFs 1 to 3) each having a half folding function to obtain printed matter, the imposition type is not only N-up imposition, but also imposition B for half folding (e.g., imposition processing performed by rotating a page through 180° and exchanging the page order for half folding).

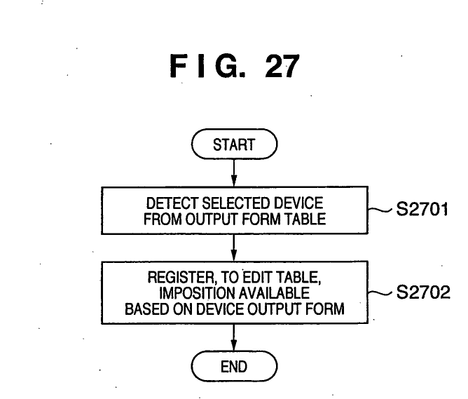

FIG. 27 is a flowchart showing detailed procedures in edit information table generation processing (S2203) shown in FIG. 22. As described above, the edit information table includes the output form table and the imposition edit table. In creating the edit information table, the output form table in FIG. 24 is created based on all device profile information, and a newly registered device is detected based on the created output form table (S2701). The imposition available based on the device output form is registered in the imposition edit table shown in FIG. 26 (S2702).

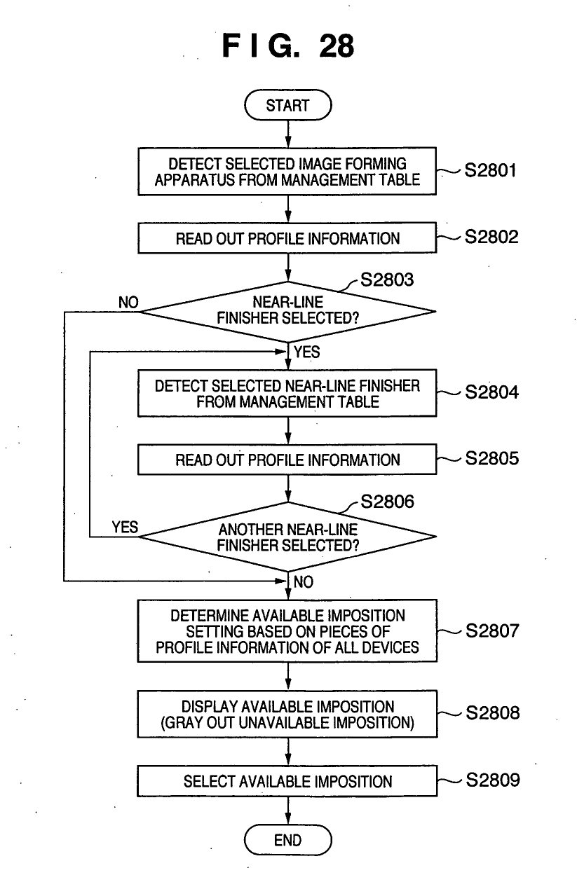

FIG. 28 is a flowchart showing detailed procedures in imposition setting processing (S2204) shown in FIG. 22. First, an image forming apparatus selected by the user on the device selection window (FIG. 20) of the bookbinding application 704 in step S2202 is detected from the device management table shown in FIG. 23 (S2801), and the profile information is read out from the storage device (S2802). If the near-line finisher is selected (YES in S2803), the corresponding near-line finisher is detected (S2804).to read out the profile information (S2805). In this processing, the above-described detection processing and read processing are continued until the pieces of profile information of all selected near-line finishers are acquired (S2806).

Upon acquisition of the profiles of all selected devices, imposition setting available by combining the devices is determined (S2807). Imposition setting for implementing each function is determined based on the function of each device, for example, the double-side printing function or N-up printing function for the printing apparatus, or the wrapping binding function for the post-processing device (bookbinding apparatus). Hence, the plurality types of imposition settings available by combining the devices can be determined based on the combination between the selected printing apparatus and post-processing device. Available imposition setting is displayed on the UI window (see FIG. 21) (S2808). When the operator points one of imposition settings displayed on the UI window with a pointing device such as the mouse 620 connected to the client PC 601, the bookbinding application 704 selects imposition setting (S2809).

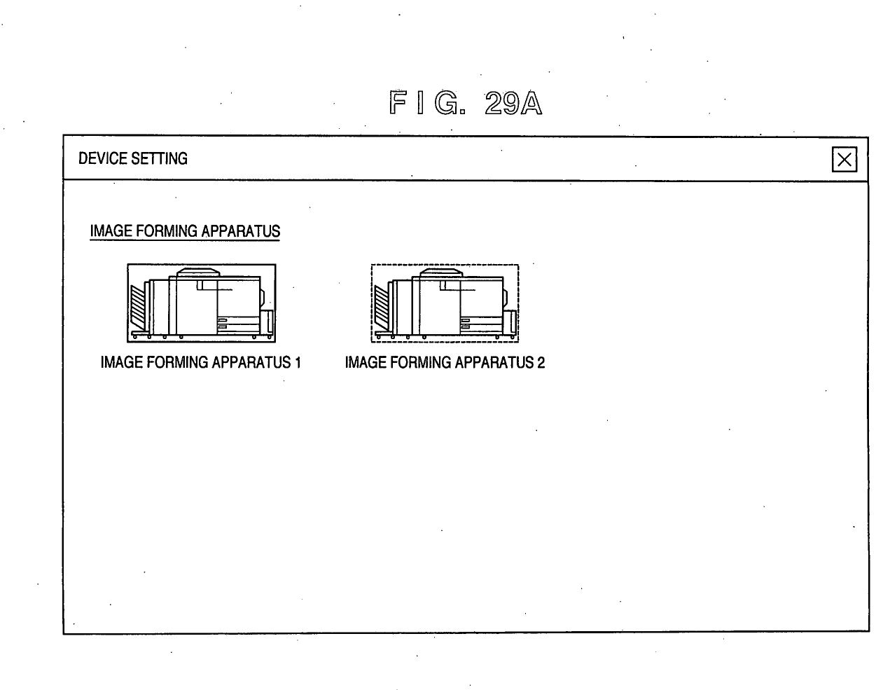

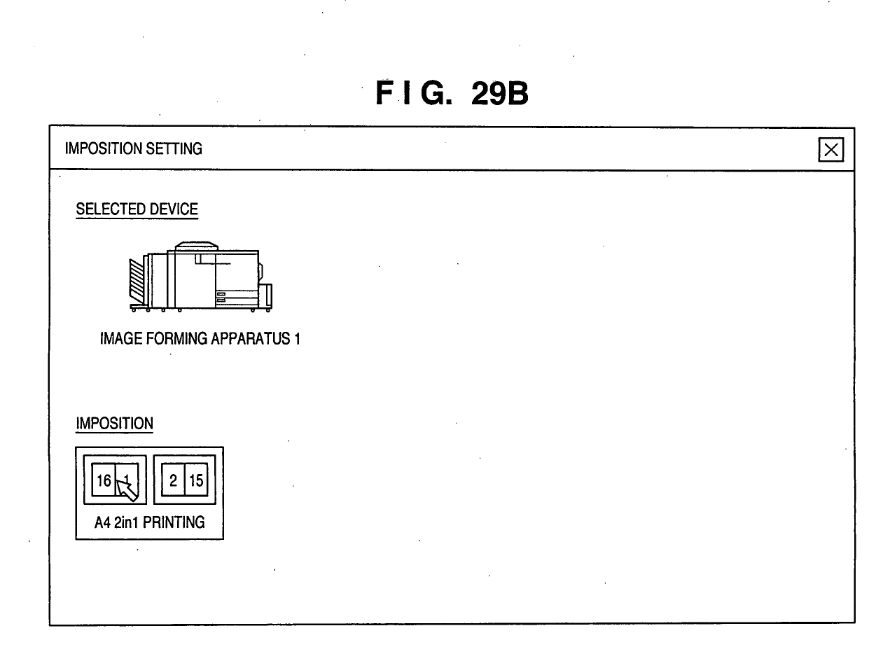

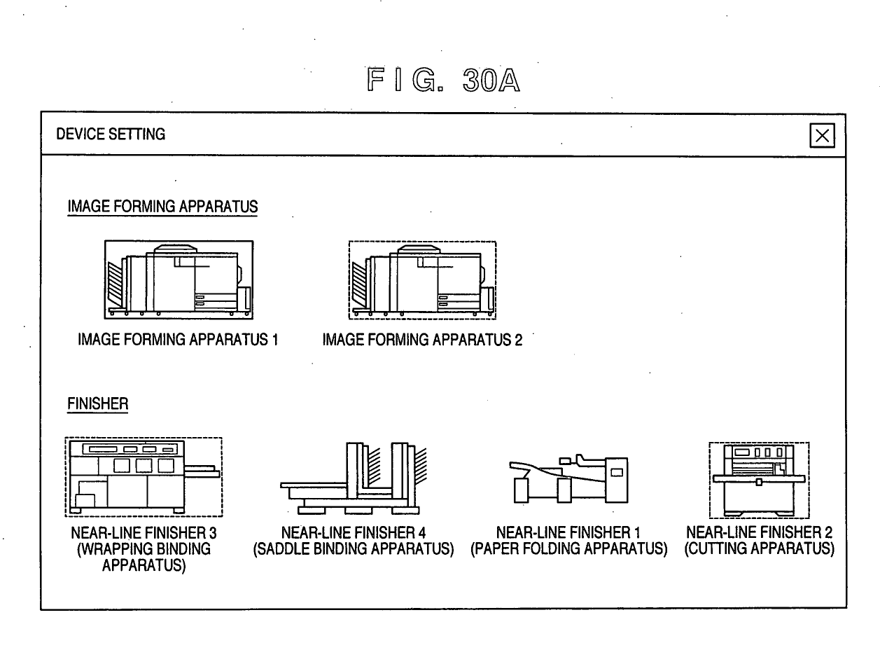

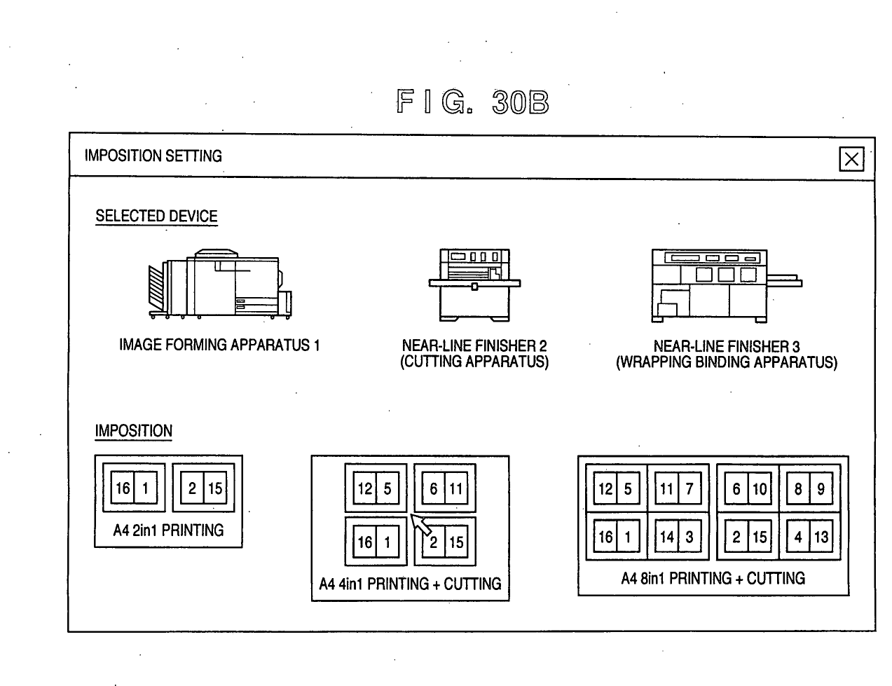

A selection scheme other than the above-described device setting selection scheme (FIG. 20) and imposition setting selection scheme (FIG. 21) will be described below. FIGS. 29A and 29B and FIGS. 30A and 30B are views showing examples of UI windows for performing device setting and imposition setting. In FIGS. 29A and 29B, only an image forming apparatus is connected to the network. In this case, when the image forming apparatus 1 is set as shown in FIG. 29A, one type of imposition setting is available as shown in FIG. 29B.

In FIGS. 30A and 30B, the image forming apparatus and the finishers are connected on the network. In this case, since the image forming apparatus 1, near-line finisher 2 (wrapping binding apparatus), and near-line finisher 3 (cutting apparatus) are selected as shown in FIG. 30A, three types of imposition settings are available as shown in FIG. 30B.

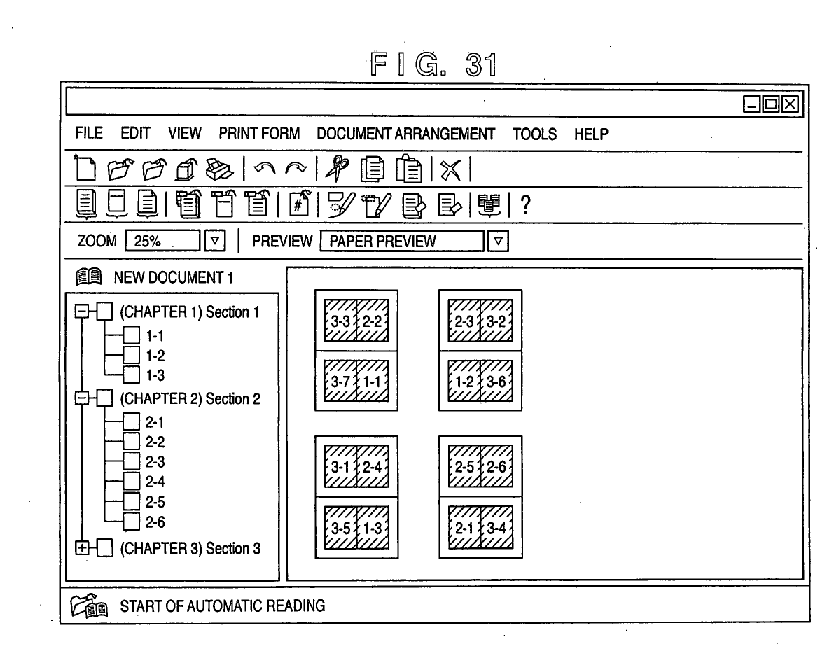

FIG. 31 is a view showing an example of preview display after device setting and imposition setting shown in FIGS. 30A and 30B. On this window, the operator confirms preview display. When the operator confirms a desired edit result, printing and output processes are performed.

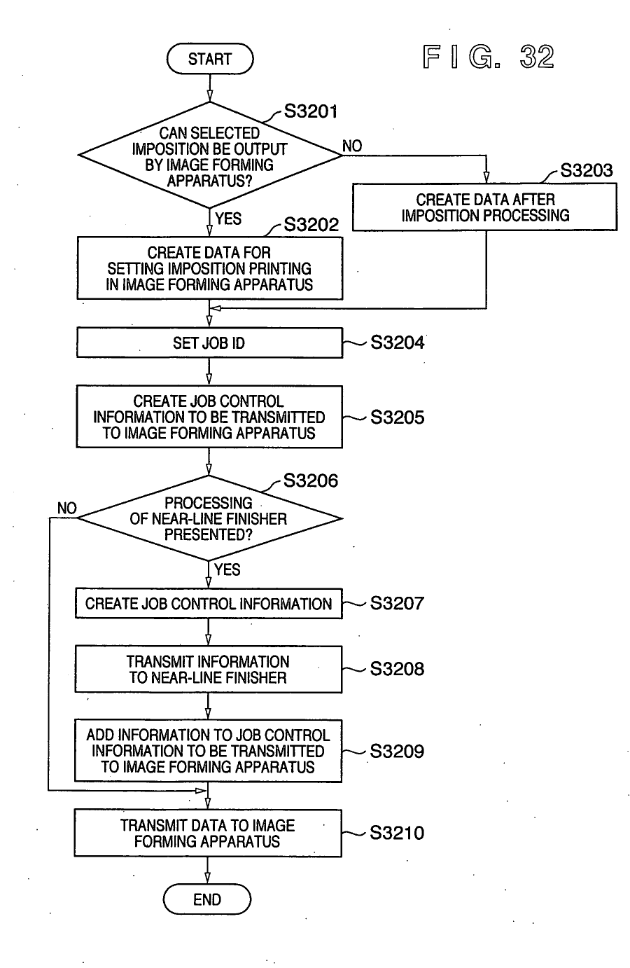

FIG. 32 is a flowchart showing detailed procedures in printing processing (S2205) shown in FIG. 22. In printing processing, first, the bookbinding application 704 determines whether imposition selected in imposition setting can be implemented by the image forming apparatus or its printer driver (S3201). This determination can be done by determining, based on the profile information and output form table of the image forming apparatus, whether the image forming apparatus supports the output form of selected imposition setting. If the image forming apparatus supports the output form, selected imposition processing can be performed by the image forming apparatus or its printer driver. If it is determined that imposition can be implemented, the bookbinding application 704 creates data for designating to perform imposition printing by the image forming apparatus or its printer driver (S3202). If selected imposition setting is based on the bookbinding function of the near-line finisher serving as the post-processing device, the image forming apparatus does not support such imposition setting. That is, if NO in step S3201, the bookbinding application 704 creates print target data after imposition processing for drawing data of the electronic document file (S3203).

Note that in this embodiment, when imposition setting is performed by combining the functions of the image forming apparatus and post-processing device, imposition processing based on such imposition setting is performed only by the bookbinding application 704. However, the present invention is not limited to this. The bookbinding application 704 may perform imposition processing to be implemented by the function of the post-processing device, and designate the printer driver 706 (or the image forming apparatus) to perform imposition processing to be implemented by the function of the image forming apparatus.

When the bookbinding application 704 has created data to be printed, a job ID is set to perform printing processing and post-processing in each device (S3204), and job control information to be transmitted to the image forming apparatus is created (S3205). Accordingly, on the basis of the job control information and the print target data generated by the bookbinding application 704, the printer driver 706 generates a printing job of the printing data to be interpreted by the image forming apparatus.

If the near-line finisher is selected in the above-described device selection processing (YES in S3206), the bookbinding application 704 creates job control information (called a job ticket) for the near-line finisher in order to designate the near-line finisher to perform processing (S3207), and the job control information of the generated job ticket is transmitted to the near-line finisher (S3208). The job control information transmitted to the near-line finisher is added to the job control information to be transmitted to the image forming apparatus (S3209), and the data is transmitted to the image forming apparatus via the printer-driver 706 (S3210).

In step S3208, the job control information is transmitted to the image forming apparatus after the job control information to be controlled by the near-line finisher is added to the job control information to be controlled by the image forming apparatus. However, the present invention is not limited to this. The printing job including only the job control information to be controlled by the image forming apparatus may be transmitted to the image forming apparatus. In this embodiment, the job control information for the near-line finisher is added in order to cause the operator to easily recognize the next step (post-processing step) by referring to the printed procedures and Job ID based on the job control information for the near-line finisher in the image forming apparatus.

<Printing Processing Flow in Image Forming Apparatus>

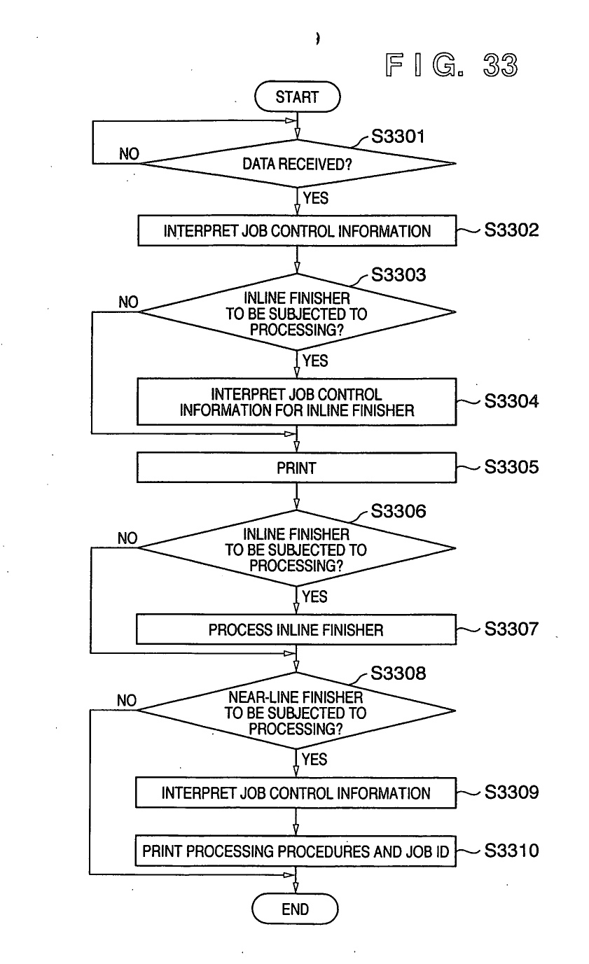

FIG. 33 is a flowchart showing printing processing in control of the MFP control unit 1420 of the image forming apparatus. When the image forming apparatus receives, from the printer driver of the client PC, a printing job which contains job control information (S3301), the MFP control unit 1420 interprets the job control information in the printing job (S3302). If the inline finisher is to be subjected to processing (YES in S3303), the job control information for the inline finisher is interpreted (S3304).

Upon interpretation of the job control information, the RIP unit 1407 converts the printing data into a bitmap image, and the printer unit 1409 performs printing processing for the converted printing data (S3305). When the image forming apparatus has printed the printing data portion, it is determined whether the inline finisher is to be subjected to processing. If the inline finisher is to be subjected to processing (YES in S3306), processing for the inline finisher is performed via the post-processing unit 1410 in accordance with the interpretation result of the job control information (S3307). After that, the MFP control unit 1420 determines whether the job control information for the near-line finisher is included in the printing job. If the near-line finisher is to be subjected to processing (YES in S3308), the job control information for the near-line finisher is interpreted (S3309) to print the procedures and job ID for the near-line finisher to be subjected to processing, on another paper sheet in a predetermined format (S3310). The predetermined format may be arbitrarily determined. However, in this format, the operator desirably recognizes the job ID and the procedures of the near-line finisher.

<Job Control Flow in Near-Line Finisher>

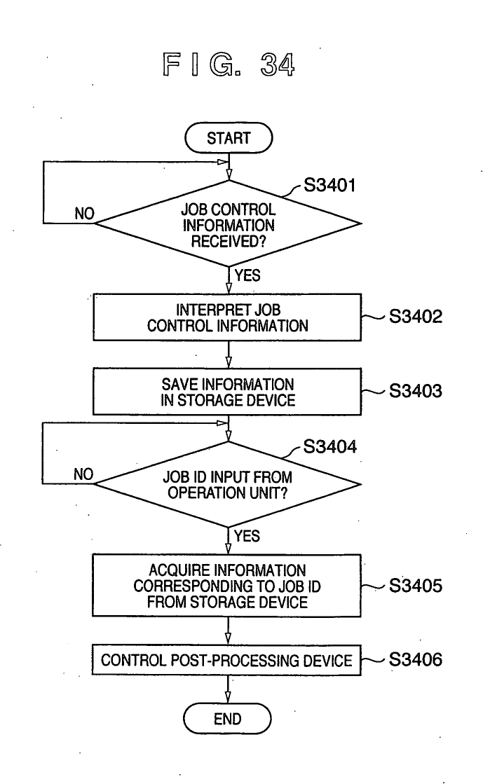

FIG. 34 is a flowchart showing job control in the near-line finisher. Upon reception of the job control information (job ticket) from the client PC via the network I/F 1511 (S3401), the job control information interpretation unit 1515 interprets the job control information (S3402). The device format is converted into a controllable internal format, and the converted format-and the job ID are saved in the storage device 1512 (S3403). When the operator inputs the ID of the processing target job with the operation unit 1514 (YES in S3404), the job control unit 1513 acquires the corresponding job control information from the storage device 1512 (S3405). The acquired job control information is set to the device control unit 1516 to control the post-processing device 1520 (S3406), and designated post-processing is then performed.

Also, the present invention may comprise the steps of adding, to the network, the server (or the MFP) which stores the job control information, registering the job control information server to the corresponding finisher, connecting the job control information server upon inputting the job ID with the operation unit, acquiring the job control information corresponding to the input Job ID, interpreting the job control information, and controlling the post-processing device.

### Second Embodiment

The second embodiment of the present invention will now be described in detail with reference to the accompanying drawings. In the first embodiment, the operator performs device setting. However, in the second embodiment, device setting is automatically selected based on an output form.

Note that the system configuration in the second embodiment is the same as that shown in FIG. 1 in the first embodiment. The descriptions of the configuration, operation, and the like of a client PC, server, image forming apparatus, and finisher are omitted.

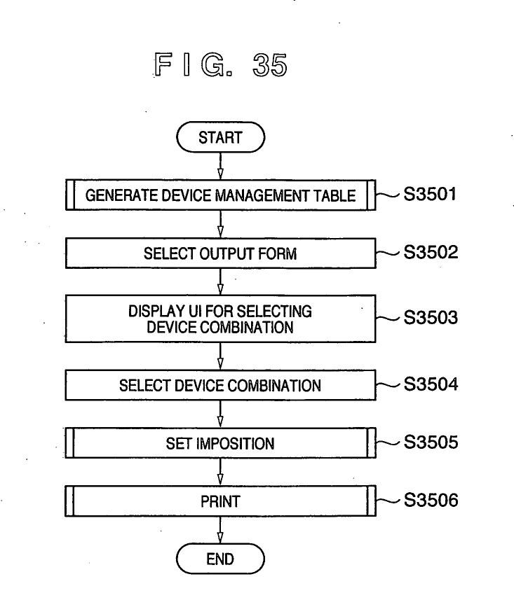

FIG. 35 is a flowchart showing printing processing in a client PC according to the second embodiment. Similarly to the first embodiment, when an operator activates a bookbinding application 704 serving as an application program for page editing in the client PC, the bookbinding application 704 generates the pieces of device information of an image forming apparatus, inline finisher, and near-line finisher on a network (S3501). As described above, the pieces of device information of the image forming apparatus and inline finisher can be acquired from a printer driver 706, and the device information of the near-line finisher can be acquired from the near-line finisher. When the operator selects a bookbinding format and the like in output form setting (window shown in FIG. 21) of the bookbinding application 704 (S3502), the combination of the corresponding devices is detected from a device management table based on the selected output form, and the detected combination is displayed on a UI (S3503). At this time, the operator selects a desired combination with a pointing device or the like (S3504). The operator then performs page editing such as imposition setting based on the selected device (S3505), and confirms the editing result on the UI to execute printing processing (S3506).

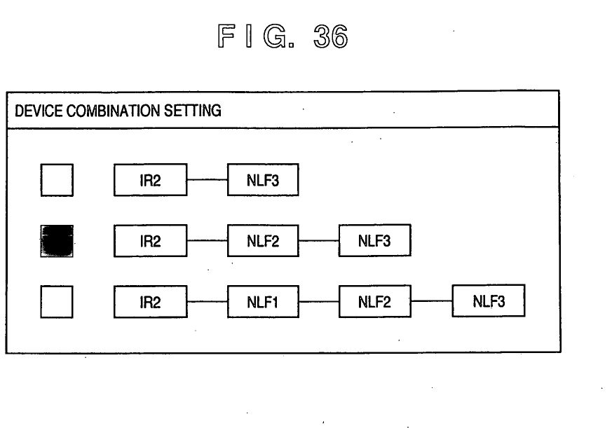

FIG. 36 is a view showing an example of a UI window for selecting the combination of devices. In the example in FIG. 36, color printing and wrapping binding are selected by combining an image forming apparatus (IR2) and near-line finishers (NLF 1, 2, and 3) shown in FIG. 1.

As described above, on the device combination selection UI, the operator can select the device combination displayed on the UI using a keyboard or the pointing device such as a mouse connected to the client PC.

Therefore, the device can be selected even when the operator does not recognize the function of each device.

In the above-described first and second embodiments, page editing by the application can be performed similarly to the inline finisher, on the basis of the job executable by the near-line finisher. Furthermore, the application can perform page editing on the basis of the job executable by combining the plurality of finishers.

The present invention provides the user with the user interface for selecting the image forming apparatus and the finisher independent of the image forming apparatus as available devices, and setting the printing function for the selected device, thereby improving user's convenience.

The present invention may be applied to a system constituted by a plurality of devices (e.g., a host computer, an interface device, a reader, a printer, and the like) or an apparatus comprising a single device (e.g., a copying machine, a facsimile apparatus, or the like).

The object of the present invention is achieved even by supplying a recording medium which records software program codes for implementing the functions of the above-described embodiments to the system or apparatus and causing the computer (or a CPU or MPU) of the system or apparatus to read out and execute the program codes stored in the recording medium.

In this case, the program codes read out from the recording medium implement the functions of the above-described embodiments by themselves, and the recording medium which stores the program codes constitutes the present invention.

As a storage medium for supplying this program codes, a floppy® disk, a hard disk, an optical disk, a magnetooptical disk, a CD-ROM, a CD-R, a magnetic tape, a nonvolatile memory card, a ROM, or the like can be used.

The functions of the above-described embodiments are realized not only when the readout program codes are executed by the computer but also when the OS (Operating System) running on the computer performs part or all of actual processing on the basis of the instructions of the program codes.

The functions of the above-described embodiments are also realized when the program codes read out from the recording medium are written in the memory of a function expansion board inserted into the computer or a function expansion unit connected to the computer, and the CPU of the function expansion board or function expansion unit performs part or all of actual processing on the basis of the instructions of the program codes.

Preferred embodiments of the present invention have been described above. However, the invention is not limited to the representative embodiments shown and described herein. It is to be understood that various modifications may be made without departing from the spirit or scope of the appended claims.

This application claims the benefit of Japanese Patent Application No. 2005-144226 filed on May 17, 2005, which is hereby incorporated by reference herein its entirety.

What is claimed is:

1. An information processing apparatus which can communicate, via a network, with an image forming apparatus and a finisher independent of the image forming apparatus as available devices, comprising:
acquisition means for acquiring pieces of device information of the image forming apparatus and the finisher as the available devices;
selection means for causing a user to select the image forming apparatus and the finisher as the available devices based on the device information acquired by said acquisition means;
setting means for causing the user to set a printing function and a post-processing function for the available device selected by said selection means;
generation means for generating printing control information for causing the selected image forming apparatus to execute the printing function set by said setting means, and generating Job control information for causing the selected finisher to execute the post-processing function set by said setting means; and
transmission means for transmitting, to the respective selected devices, the printing control information and the job control information which are generated by said generation means.

2. The apparatus according to claim 1, wherein the finisher is a near-line finisher connected via the network, and said selection means includes a user interface for causing the user to select the near-line finisher as the available device.

3. The apparatus according to claim 2, wherein said selection means causes the user to select the plurality of near-line finishers as the available devices using the user interface.

4. The apparatus according to claim 1, wherein said setting means creates a printing setting window based on the post-processing printing function of the selected near-line finisher so that new imposition processing which is not supported by the image forming apparatus can be performed.

5. The apparatus according to claim 2, wherein said selection means causes the user to select a combination between the image forming apparatus and at least one of the near-line finishers as available devices.

6. The apparatus according to claim 5, wherein said setting means causes the user to set the printing function for the combination of the selected devices.

7. The apparatus according to claim 1, further comprising:
means for selecting, as an output form, a combination between the image forming apparatus and the near-line finisher connected via the network; and
means for automatically selecting the combination based on the selected output form.

8. A device selection method for an information processing apparatus which can communicate, via a network, with an image forming apparatus and a finisher independent of the image forming apparatus as available devices, comprising:
an acquisition step of acquiring pieces of device information of the image forming apparatus and the finisher as the available devices;
a selection step of causing a user to select the image forming apparatus and the finisher as the available devices based on the device information acquired in the acquisition step;
a setting step of causing the user to set a printing function and a post-processing function for the available device selected in the selection step;
a generation step of generating printing control information for causing the selected image forming apparatus to execute the printing function set in the setting step, and generating job control information for causing the selected finisher to execute the post-processing function set in the setting step; and
a transmission step of transmitting, to the respective selected devices, the printing control information and the job control information which are generated in the generation step.

9. The method according to claim 8, wherein the finisher is a near-line finisher connected via the network, and in the selection step, the user selects the near-line finisher as the available device using a user interface.

10. The method according to claim 9, wherein in the selection step, the user selects the plurality of near-line finishers as the available devices using the user interface.

11. The method according to claim 8, wherein in the setting step, a printing setting window is created based on the post-processing printing function of the selected near-line finisher so that new imposition processing which is not supported by the image forming apparatus can be performed.

12. The method according to claim 9, wherein in the selection step, the user selects a combination between the image forming apparatus and at least one of the near-line finishers as available devices.

13. The method according to claim 12, wherein in the setting step, the user sets the printing function for the combination of the selected devices.

14. The method according to claim 8, further comprising steps of:
selecting, as an output form, a combination between the image forming apparatus and the near-line finisher connected via the network; and
automatically selecting the combination based on the selected output form.

15. A program for causing a computer to execute a device selection method, the device selection method comprising:
an acquisition step of acquiring pieces of device information of an image forming apparatus and a finisher as available devices;
a selection step of causing a user to select the image forming apparatus and the finisher as the available devices based on the device information acquired in the acquisition step;
a setting step of causing the user to set a printing function and a post-processing function for the available device selected in the selection step;
a generation step of generating printing control information for causing the selected image forming apparatus to execute the printing function set in the setting step, and generating job control Information for causing the selected finisher to execute the post-processing function set in the setting step; and
a transmission step of transmitting, to the respective selected devices, the printing control information and the Job control information which are generated in the generation step.

16. A computer-readable recording medium which records a program, the program comprising the codes of:
an acquisition step of acquiring pieces of device information of an image forming apparatus and a finisher as available devices;
a selection step of causing a user to select the image forming apparatus and the finisher as the available devices based on the device information, acquired in the acquisition step;
a setting step of causing the user to set a printing function and a post-processing function for the available device selected in the selection step;
a generation step of generating printing control information for causing-the selected image forming apparatus to execute the printing function set in the setting step, and generating job control information for causing the selected finisher to execute the post-processing function set in the setting step; and
a transmission step of transmitting, to the respective selected devices, the printing control information and the job control information which are generated in the generation step.
